(19) United States
(12) Patent Application Publication
(10) Pub. No.: US 2024/0419605 A1
(43) Pub. Date: Dec. 19, 2024

(54) SEMICONDUCTOR DEVICE

(71) Applicant: Renesas Electronics Corporation, Tokyo (JP)

(72) Inventors: Ryuichi IGARASHI, Tokyo (JP); Katsushige MATSUBARA, Tokyo (JP); Kazuaki TERASHIMA, Tokyo (JP)

(21) Appl. No.: 18/646,506

(22) Filed: Apr. 25, 2024

(30) Foreign Application Priority Data
Jun. 14, 2023 (JP) 2023-097830

(51) Int. Cl. G06F 12/1045; G06F 7/544; G06F 12/06

(52) U.S. Cl. CPC G06F 12/1045; G06F 7/5443; G06F 12/0653

(57) ABSTRACT

A semiconductor device includes a scratchpad memory, a memory controller, and a MAC (multiply-accumulation) unit. The scratchpad memory is configured to store image data of N channels and includes M memories which are individually accessible, wherein M is integer of at least 2 and N is an integer of at least 2. The memory controller controls access to the scratchpad memory such that pixel data of the N channels which are arranged at a same position in image data of the N channels are respectively stored in difference memories in the M memories. The MAC unit includes a plurality of calculators to calculate pixel data of the N channels read from the scratchpad memory by using the memory controller and a weight parameter.

### CROSS-REFERENCE TO RELATED APPLICATIONS

The disclosure of Japanese Patent Application No. 2023-097830 filed on Jun. 14, 2023, including the specification, drawings and abstract is incorporated herein by reference in its entirety.

### BACKGROUND

The present invention relates to a semiconductor device and, for example, to a semiconductor device for executing a neural network process.

Patent Document 1 discloses an image recognition device with an integration coefficient table generation device and input pattern generation circuit to execute efficiently convolution arithmetic operations in CNN (Convolutional Neural Network). The integration coefficient table generation device integrates two types of 3×3 input coefficient tables into one type of 5×5 integration coefficient table, and outputs the same to a 5×5 convolution arithmetic operation circuit. The input pattern generation circuit generates pixel values of 5×5 pixels from pixel values of 3×3 pixels stored in the line buffer based on the rule set in the input pattern register, and outputs the pixel values to the 5×5 convolution arithmetic operation circuit.
[Patent Document 1] Japanese unexamined Patent Application publication No. 2019-40403

### SUMMARY

In a semiconductor device, which is responsible for image processing such as CNN, for example, the calculation of a plurality of channels in a convolution layer is performed in parallel by using a plurality of multiply-accumulation calculators included in a MAC (Multiply Accumulation) unit, thereby realizing an improvement in performance, in particular, a reduction in processing times. In this case, in order to further enhance the effective performance, it is desired to reduce the input/output latency between the scratchpad memory (also referred to as SPM in the specification) in which the image data of a plurality of channels is stored and MAC unit.

Here, in order to reduce the input/output latency between SPM and MAC unit, for example, a method of using a dedicated data format in which image data of a plurality of channels is integrated for data transfer between SPM and MAC unit is conceivable. However, the image data of a plurality of channels stored in SPM may be processed by a general-purpose signal processing circuit, such as a DSP (Digital Signal Processor), instead of MAC unit in a series of image processing. A general-purpose signal processing circuit cannot support the dedicated data format. Therefore, even when a dedicated data format is used for transferring data between SPM and MAC unit, there is a possibility that the processing times of the image processing cannot be sufficiently shortened.

Embodiments described below have been made in view of the above, and other problems and novel features will be apparent from the description of the present specification and the accompanying drawings.

A semiconductor device according to one aspect includes a scratchpad memory, a memory controller, and a MAC (multiply-accumulation) unit. The scratchpad memory is configured to store image data of N channels and includes M memories which are individually accessible, wherein M is integer of at least 2 and N is an integer of at least 2. The memory controller controls access to the scratchpad memory such that pixel data of the N channels which are arranged at a same position in image data of the N channels are respectively stored in difference memories in the M memories. The MAC unit includes a plurality of calculators to calculate pixel data of the N channels read from the scratchpad memory by using the memory controller and a weight parameter.

A semiconductor device according to another aspect includes a scratchpad memory, a memory controller and a CPU (Central Processing Unit) and a MAC (Multiply Accumulation) Unit. The scratchpad memory stores image data of N channels and includes M memories which are individually accessible, where M is an integer of 2 or more and N is an integer of 2 or more. The memory controller is configured to control access to the scratchpad memory based on a setting value of a register. The CPU is configured to determine the setting value of the register for the memory controller. The MAC unit includes a plurality of calculators. The CPU determines the setting value of the register such that pixel data of N channels which are arranged at a same pixel position in image data of the N channels are respectively stored in different memories of the M memories, and each of the calculators performs a multiply-accumulation operation on the pixel data of the N channels read from the scratchpad memory by using the memory controller and a weight parameter.

A semiconductor device according to still another aspect includes a scratchpad memory which stores D-dimensional data and including M memories which are individually accessible, the D-dimensional data being configured such that each data in one dimension is distinguished by an index value, where D is an integer of 2 or more and M is an integer of 2 or more, and a memory controller is configured to control access to the scratchpad memory such that N pieces of data having a same index value in the first to (D-1)th dimensions are respectively stored in different memories in the M memories, with the number of the index value in the D dimension being N.

By using semiconductor device of one or more embodiments, the processing times of the image processing can be shortened.

### BRIEF DESCRIPTION OF THE DRAWINGS

FIG. 1 is a diagram illustrating a schematic configuration of a semiconductor device according to a first embodiment.

FIG. 2 is a schematic diagram illustrating a configuration example of a neural network.

FIG. 3 is a schematic diagram illustrating an exemplary process for an intermediate layer in CNN in semiconductor device illustrated in FIG. 1.

FIG. 4 is a diagram for explaining an operation example of the memory controller in FIG. 1, and is a diagram illustrating an example of a memory map of image data of respective channels stored in a scratchpad memory (SPM).

FIG. 5A shows a timing chart in which a schematic operation example of the neural network engine (NNE) in FIG. 1 is compared with a case in which the system of the first comparative example is used and a case in which the system of the embodiment is used.

FIG. 5B is a diagram illustrating an example of a case in which the number of clock cycles required for the process of the convolution layer of one layer is compared between the case in which the method of the first comparative example is used and the case in which the method of the embodiment is used.

FIG. 6 is a schematic diagram for explaining the influence on the input/output latency occurring in the entire image processing using the neural network on the premise that the memory map shown in FIG. 4 is used.

FIG. 7 is a diagram illustrating various exemplary configurations of the scratchpad memory (SPM) in FIG. 1.

FIG. 8 is a diagram illustrating an example of a memory map different from that illustrated in FIG. 4, which corresponds to Example 2-2 in FIG. 7.

FIG. 9 is a block diagram illustrating a detailed configuration of a main part of semiconductor device illustrated in FIG. 1.

FIG. 10A is a schematic diagram showing a configuration example and a part of an operation example of the address router in FIG. 9.

FIG. 10B is a diagram illustrating an operation example of the address router shown in FIG. 10A.

FIG. 10C is a diagram illustrating a different operation example than FIG. 10B.

FIG. 10D is a diagram illustrating a different operation example than FIG. 10B.

FIG. 10E is a diagram illustrating a different operation example than FIG. 10B.

FIG. 11 is a schematic diagram illustrating a configuration example and a partial operation example of the data router for write in FIG. 9.

FIG. 12 is a schematic diagram illustrating a configuration example of a data router for read in FIG. 9.

FIG. 13 is a flowchart illustrating an example of processing of the channel stride correction unit in FIG. 9.

FIG. 14 is a diagram illustrating a detailed configuration of a main part of semiconductor device according to the second embodiment.

FIG. 15 is a diagram illustrating a detailed configuration of a main part of semiconductor device according to the third embodiment.

FIG. 16 is a block diagram illustrating a detailed configuration example of a main part different from that of FIG. 15.

FIG. 17 is a schematic diagram illustrating an example of four-dimensional data format used in semiconductor device according to the fourth embodiment.

FIG. 18A is a diagram illustrating a specific embodiment of a D-dimensional format in semiconductor device according to the fourth embodiment.

FIG. 18B is a schematic diagram illustrating an arrangement configuration of data to be accessed in parallel in a four-dimensional format based on the format shown in FIG. 18A.

FIG. 18C is a diagram showing the start address and the end address of the respective pieces of data shown in FIG. 18B.

FIG. 18D is a diagram illustrating an example of neural network software executed by CPU based on the format shown in FIG. 18A.

FIG. 18E is a diagram illustrating an example of memory map of the respective data that is stored in the scratchpad memory (SPM) after the stride correction is performed based on the format shown in FIG. 18C.

FIG. 19 is a diagram illustrating an example of a memory map of image data of respective channels stored in a scratchpad memory (SPM) in semiconductor device as the first comparative example.

FIG. 20 is a schematic diagram for explaining the influence on the input/output latency occurring in the entire image processing using the neural network on the premise that the memory map shown in FIG. 19 is used.

FIG. 21 is a schematic diagram for explaining an influence on the input/output latency occurring in the entire image processing using the neural network in a semiconductor device as a second comparative example.

FIG. 22 is a diagram illustrating an example of a memory map as a comparative example of FIG. 8.

### DETAILED DESCRIPTION

In the following embodiments, when required for convenience, the description will be made by dividing into a plurality of sections or embodiments, but except when specifically stated, they are not independent of each other, and one is related to the modified example, detail, supplementary description, or the like of part or all of the other. In the following embodiments, the number of elements, etc. (including the number of elements, numerical values, quantities, ranges, etc.) is not limited to the specific number, but may be not less than or equal to the specific number, except for cases where the number is specifically indicated and is clearly limited to the specific number in principle. Furthermore, in the following embodiments, it is needless to say that the constituent elements (including element steps and the like) are not necessarily essential except in the case where they are specifically specified and the case where they are considered to be obviously essential in principle. Similarly, in the following embodiments, when referring to the shapes, positional relationships, and the like of components and the like, it is assumed that the shapes and the like are substantially approximate to or similar to the shapes and the like, except for the case in which they are specifically specified and the case in which they are considered to be obvious in principle, and the like. The same applies to the above numerical values and ranges.

Hereinafter, embodiments are described in detail with reference to the drawings. In all the drawings for explaining the embodiments, members having the same functions are denoted by the same reference numerals, and repetitive descriptions thereof are omitted. In the following embodiments, descriptions of the same or similar parts will not be repeated in principle except when particularly necessary.

### First Embodiment

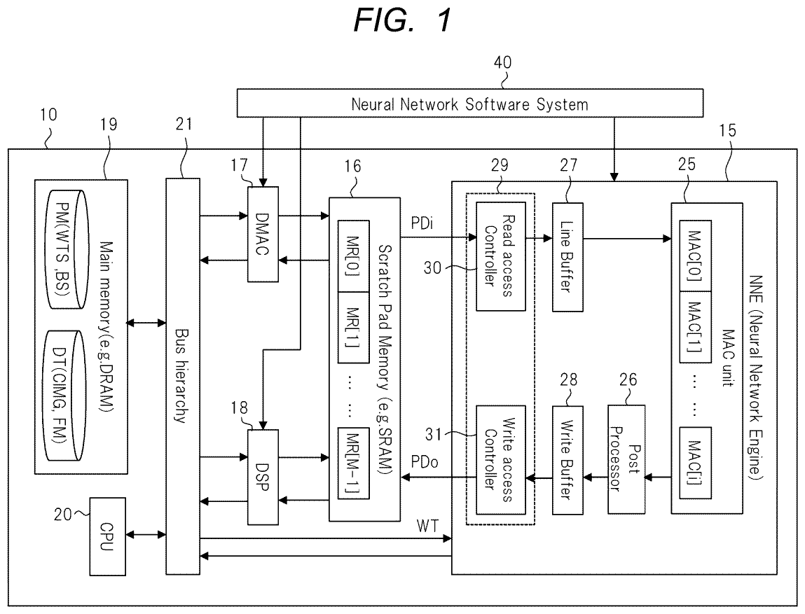

FIG. 1 is a schematic diagram illustrating an example of a configuration of a semiconductor device according to a first embodiment; The semiconductor device 10 illustrated in FIG. 1 is, for example, a SoC (System on a Chip) or a microcontroller realized by a single semiconductor chip. The semiconductor device 10 includes a neural network engine (also referred to herein as a NNE) 15, a scratchpad memory (SPM) 16, a DMA (Direct Memory Access) controller (DMAC) 17, a DSP 18, a main memory 19, a CPU (Central Processing Unit) 20, and a system bus 21. The NNE 15, the DMAC 17, the DSP 18, the main memory 19, and the CPU 20 are connected to the system bus 21.

The NNE 15 executes a neural network process represented by CNN. The SPM 16 includes M memories, MR[0] to MR[M-1], accessible in parallel to each other, where M is an integer of 2 or more. In the specification, M memories, MR[0] to MR[M-1], are collectively referred to as memory MR. The memory MR is, for example, a SRAM. The SPM 16 is used as a high-speed cache memory of NNE 15 and stores image data input and output to and from the NNE 15. The SPM 16 is also accessible from the DSP 18. The DSP 18 is one of general-purpose signal processing circuit and performs a part of neural network process on the image data DT stored in the SPM 16, for example.

The main memory 19 is, for example, a DRAM. The main memory 19 stores image data DT, parameter PM, and the like used in the neural network process. The image data DT includes, for example, camera image CIMG obtained from a camera and feature map FM generated by the neural network process. The parameter PM includes a weight parameter set WTS including a plurality of weight parameter WT according to a kernel-size, and a bias parameter BS. The main memory 19 may be provided outside the semiconductor device 10.

The DMAC 17 is the other one of the general-purpose signal processing circuits, and controls data transfer between the SPM 16 and the main memory 19 via the system bus 21. For example, the CPU 20 executes software (not shown) stored in the main memory 19 to cause the entire semiconductor device 10 to perform desired functions. As one of them, the CPU 20 constructs the neural network software system 40 by executing the neural network software. The neural network software system 40, for example, performs various settings, start-up control, and the like on the NNE 15, the DMAC 17 and the DSP 18 to control the operation sequence of the entire image processing including the neural network process.

Specifically, the NNE 15 includes a MAC unit 25, a post processor 26, a line buffer 27, a write buffer 28, and a memory controller 29. The memory controller 29 includes a read access controller 30 and a write access controller 31. The read access controller 30 reads each pixel data PDi constituting the image data DT from the SPM 16, and stores pixel data PDi in the line buffer 27. The write access controller 31 writes pixel data PDo stored in the write buffer 28 to the SPM 16.

The MAC unit 25 includes i multiply-accumulation calculators MAC[0] to MAC[i], where i is an integer of 2 or more. In the specification, the i multiply-accumulation calculators MAC[0] to MAC[i] are collectively referred to as multiply-accumulation calculator MAC. The multiply-accumulation calculator MAC performs multiply-accumulation operations on each pixel data PDi stored in the line buffer 27 and each weight parameter WT inputted in advance. At this time, the MAC unit 25 reads the weight parameter set WTS from the main memory 19 in advance by using a controller (not shown).

Further, the multiply-accumulation calculator MAC obtains the pixel data PDo by the multiply-accumulation operation of the pixel data PDi and the weight parameter WT and the like and stores the pixel data PDo in the write buffer 28 via the post processor 26. The post processor 26 generates the pixel data PDo by performing addition of the bias parameter BS, operation of the activation function, pooling process, or the like as needed on the multiply-accumulation operation performed by the multiply-accumulation calculator MAC.

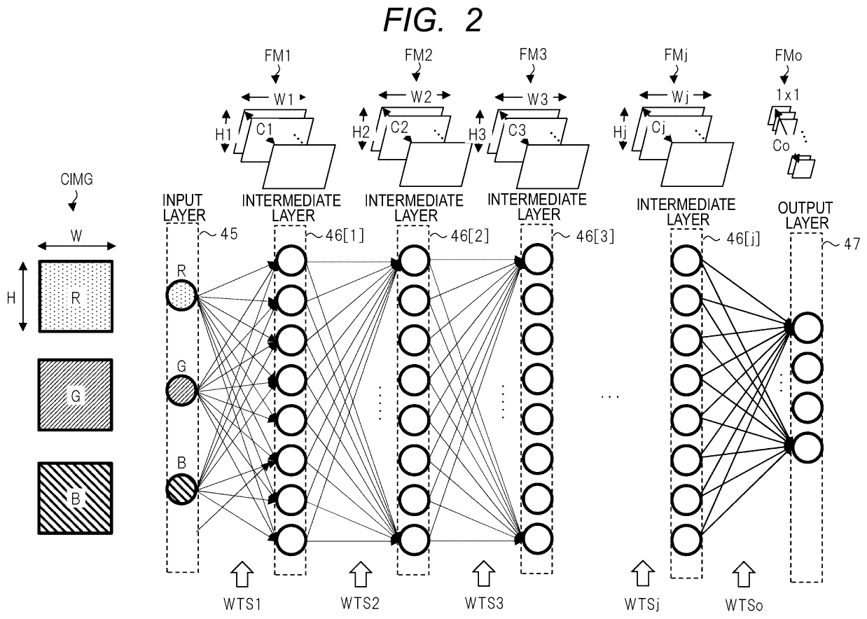

FIG. 2 is a schematic diagram illustrating a configuration example of a neural network. The neural network generally has one input layer 45, a plurality of intermediate layers 46[1] to 46[j], and one output layer 47. The input layer 45 stores, for example, image data DT of three channels including R (red), G (green), and B (blue), that is, camera image CIMG, and the like.

In the intermediate layers 46[1] to 46[j], operation results obtained by multiply-accumulation operation of the previous layer and the weight parameter sets WTS1 to WTSj or the like are stored as the image data DT, that is, the feature map FM1 to FMj. The respective feature map FM, for example, FMj, has a size of Wj×Hj×Cj with the size in the width-direction or the X-direction being Wj, the size in the height-direction or the Y-direction being Hj, and the number of channels being Cj.

The output layer 47 stores, as the feature map FMo, operation results obtained by, for example, a multiply-accumulation operation of the last intermediate layer 46[j] and the weight parameter set WTSo. The feature map FMo is, for example, sized 1×1×Co with the number of channels as Co. The feature map FMo is an image processing result by using the neural network. The image processing result is typically stored in the main memory 19.

The semiconductor device 10 illustrated in FIG. 1 executes a neural network process in the following manner for the neural network illustrated in FIG. 2. (A) First, a camera input interface (not shown) in the semiconductor device 10 stores image data DT from an external camera, that is, camera image CIMG, in the main memory 19. (B) Subsequently, the DMAC 17 stores the camera image CIMG in the SPM 16 by transferring the camera image CIMG stored in the main memory 19 to the SPM 16. As a result, the input layer 45 is formed on the SPM 16.

(C) Next, the NNE 15 or the DSP 18 performs an operation using the input layers 45 formed in the SPM 16 and the weight parameter set WTS1 stored in the main memory 19 as inputs, and stores, in the SPM 16, the feature map FM1 as the operation result. As a result, the intermediate layer 46[1] is formed on the SPM 16. Whether to use the NNE 15 or the DSP 18 to perform the operation is determined by the neural network software system 40. Such a determination applies similarly to the other layers.

(D) Subsequently, the NNE 15 or the DSP 18 performs an operation using the intermediate layer 46[1] formed on the SPM 16 and the weight parameter set WTS2 stored in the main memory 19 as inputs, and stores, in the SPM 16, the feature map FM2 as an operation result. As a result, the intermediate layer 46[2] is formed on the SPM 16. By performing the same process thereafter, the last intermediate layers 46[j] is formed on the SPM 16.

(E) Next, the NNE 15 or the DSP 18 performs an operation using the intermediate layer 46[j] of the last stage formed in the SPM 16, that is, the feature map FMj and the weight parameter set WTSo stored in the main memory 19 as inputs, and stores the operation result in the SPM 16 as the feature map FMo. As a result, the output layer 47 is formed on the SPM 16. (F) Finally, the DMAC 17 transfers the output layer 47 formed on the SPM 16, that is, the feature map FMo as the image processing result, to the main memory 19.

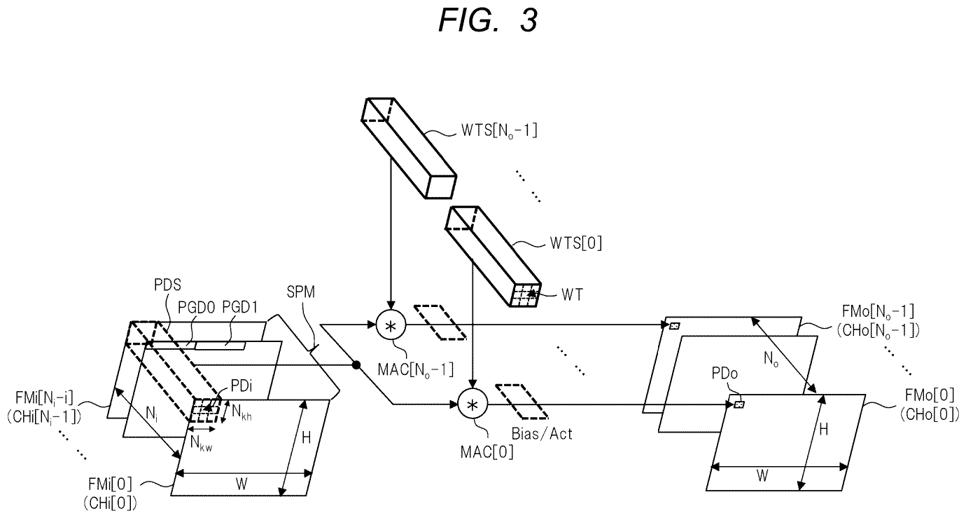

FIG. 3 is a schematic diagram illustrating an exemplary process for an intermediate layer in CNN in the semiconductor device illustrated in FIG. 1. The intermediate layer to be processed, i.e., the convolution layer, is supplied with the feature maps FMi[0] to FMi[Nᵢ-1] of Nᵢ input channels CHi[0] to CHi[Nᵢ-1] from the convolution layer of the preceding stage, and the weight parameter sets WTS[0] to WTS[Nₒ-1] of No output channels assigned to the convolution layer to be processed.

The feature maps FMi[0] to FMi[Nᵢ-1] are stored in the SPM 16, and the weight parameter sets WTS[0] to WTS[Nₒ-1] are stored in the main memory 19. The feature map FM of each channel has a size of W×H, where W is the size in the width-direction and H is the size in the height-direction. Each of the weight parameter sets WTS[0] to WTS[Nₒ-1] includes N_{kw}×Nₖₕ×Nᵢ weight parameters WTs where N_{kw} is the number in the width-direction, Nₖₕ is the number in the height-direction, and Nᵢ is the number of inputted channels. N_{kw}×Nₖₕ is a kernel-size, typically 3×3 or the like.

Here, in the embodiment of FIG. 3, the multiply-accumulation calculator MAC[0] performs a multiply-accumulation operation on the pixel data set PDS of a predetermined size based on a certain pixel position included in the feature map FMi[0] to FMi[Nᵢ-1] and the weight parameter set WTS[0] of the output channel CHo[0]. The addition of the bias parameter BS and the operation of the activation function are performed on the result of the multiply-accumulation operation, so that the pixel data PDo of the pixel position serving as a reference in the feature map FMo[0] of the output channel CHo[0] is generated. Note that the pixel data set PDS includes N_{kw}×Nₖₕ×Nᵢ pixel data PDi in the same manner as the weight parameter set WTS.

In addition, in parallel with the operation in the multiply-accumulation calculator MAC[0], the multiply-accumulation calculator MAC[Nₒ-1] performs a multiply-accumulation operation on the same pixel data set PDS used by the multiply-accumulation calculator MAC[0] and the weight parameter set WTS[Nₒ-1] of the output channel CHO[Nₒ-1] that differs from the case of the multiply-accumulation calculator MAC[0]. The addition of the bias parameter BS and the operation of the activation function are performed on the result of the multiply-accumulation operation, so that the pixel data PDo of the pixel position serving as a reference in the feature map FMo[Nₒ-1] of the output channel CHO[Nₒ-1] is generated.

Then, the above-described process is performed while sequentially shifting the reference pixel position in the width-direction or the height-direction, so that all the pixel data PDo constituting the feature maps FMo[0] to FMo[Nₒ-1] of Nₒ output channels are generated. The feature maps FMo[0] to FMo[Nₒ-1] of Nₒ output channels are stored in the SPM 16 as image data DT. The image data DT stored in the SPM 16 in this way is input to the convolution layer of the next stage, for example, and is used as the feature maps FMi[0] to FMi[Nᵢ-1] of the Nᵢ=Nₒ input channels. Note that the convolution process as shown in FIG. 3 is represented by Expression (1).

$$\begin{matrix}[ Expression 1 ] & \\ FMo [ o ] [ y ] [ x ] = {\sum }_{o = 0}^{{N}_{o} - 1} {\sum }_{y = 0}^{H - 1} {\sum }_{x = 0}^{W - 1} {\sum }_{i = 0}^{{N}_{i} - 1} {\sum }_{kh = - N / 2}^{{N}_{kh} / 2} {\sum }_{kw = - N / 2}^{{N}_{kw} / 2} WT [ o ] [ i ] [ kh ] [ kw ] \times FMi [ i ] [ y + kh ] [ x + kw ] & ( 1 )\end{matrix}$$

FMo: feature map (output)
FMi: feature map (input)
WT: weight parameter
[x]: pixel position in X-direction (horizontal)
[y]: line position in Y-direction (vertical)
[kw]: kernel position in X-direction (horizontal)
[kh]: kernel position in Y-direction (vertical)
Nₒ: number of output channels
Nᵢ: number of input channels
N_{kw}: kernel size in X-direction (horizontal)
Nₖₕ: kernel size in Y-direction (vertical)
W: pixel size in X-direction (horizontal)
H: line size in Y-direction (vertical)

### COMPARATIVE EXAMPLES

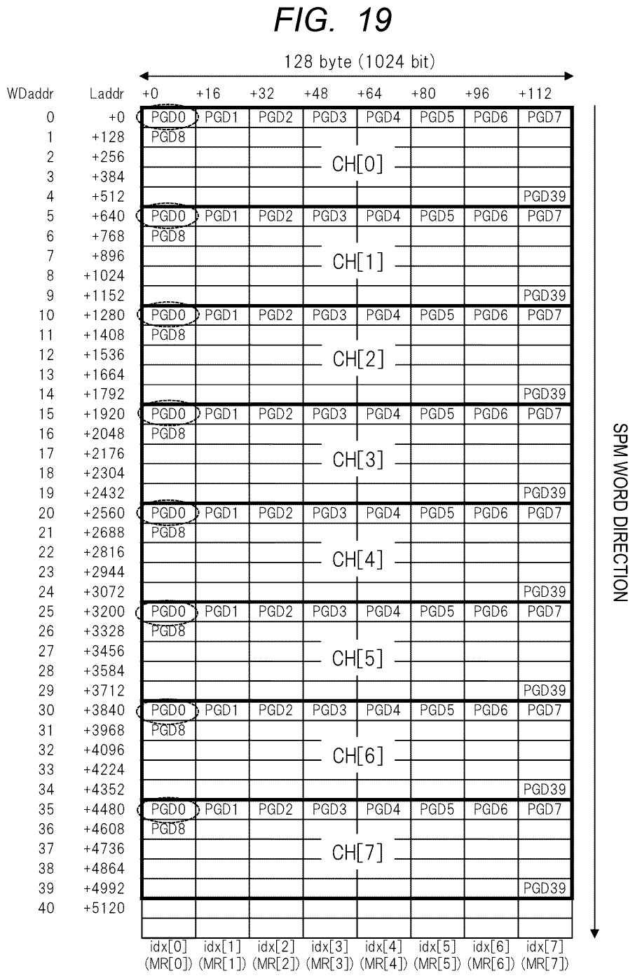

FIG. 19 is a diagram illustrating an example of a memory map of image data of respective channels stored in a scratchpad memory (SPM) in a semiconductor device as a first comparative example. In this case, the SPM 16 has eight memories MR[0] to MR[7], and the respective memory MR has a bit-width of 16 bytes (=128 bits). That is, the memory bus width of the SPM 16 is 128 bytes (=16-byte×8).

Here, the size of the image data of one channel is 640 bytes consisting of 64 bytes/row×10 row in a raster structure. In this case, when, by using Planar format, which is one of the general-purpose formats, for example, the image data DT of eight channels CH[0] to CH[7] are stored in the SPM 16 in raster order, a memory map as shown in FIG. 19 is formed. For example, the plurality of pixel group data PGD0 to PGD3 in the respective channels corresponds to the data of the first row in the raster structure. The plurality of pixel group data PGD4 to PGD7 corresponds to the data of the second row in the raster structure. In the present specification, the plurality of pixel group data PGD0 to PGD7 are collectively referred to as a pixel group data PGD.

The image data DT of the eight channels CH[0] to CH[7] in FIG. 19 correspond to, for example, the feature maps FMi[0] to FMi[7] of the eight channels serving as the input data or the feature maps FMo[0] to FMo[7] of the eight channels serving as the output data in FIG. 3. The pixel group data PGD0 included in the image data DT of the channel CH[0] corresponds to, for example, a data group of 16 bytes in the width-direction, for example, 16 pixels in the feature map FMi[0] illustrated in FIG. 3. The subsequent pixel group data PGD1 corresponds to a data group of 16 bytes following the pixel group data PGD0 in the width-direction. As described above, the pixel group data PGD includes a plurality or a single pixel data PDi, and is the minimum data unit when the memory controller 29 accesses the SPM 16.

The pixel data set PDS shown in FIG. 3 corresponds to the data group outputted from the line buffer 27 to the MAC unit 25 in FIG. 1. Specifically, the line buffer 27 outputs, for example, a plurality of pixel data sets PDSs for a convolution operation in width-direction, that is, the shifted pixel data sets PDSs, to the MAC unit 25 in one clock cycle. The MAC unit 25 can also perform operations on the plurality of pixel data sets PDS in parallel in one clock cycle.

The line buffer 27 sequentially switches the positions of the plurality of pixel data sets PDS outputted to MAC unit 25 every clock cycle in the width-direction or the height-direction. As the positions are switched, a plurality of new pixel data PDi are required in addition to the pixel data PDi already acquired in the line buffer 27, in other words, in addition to the pixel data PDi that can be repeatedly used in accordance with the convolution operation.

The read access controller 30 transfers the newly required plurality of pixel data PDi, for example, pixel group data PGD of eight channels CH[0] to CH[7], from the SPM 16 to the line buffer 27. With such a process, in the steady-state, data transfer from the SPM 16 to the line buffer 27, data transfer from the line buffer 27 to MAC unit 25, and MAC operation in MAC unit 25 are processed in a pipeline.

Here, the logical address Laddr of the SPM 16 in FIG. 19 is expressed by Expression (2) using the physical addresses of the M memories MR[0] to MR[M-1], for example, word address WDaddr, and index (idx) having a range of 0 to M-1 for identifying the M memories MR [0] to MR [M-1].

$$Laddr = WDaddr \times 128 + ( idx \times 16 ) \qquad ( 2 )$$

Thus, in the memory map shown in FIG. 19, N is an integer of 2 or more, and the pixel data PD of the N channels arranged at the same pixel position in the image data DT of the N channels, or the pixel group data PGD, are stored in the same memory MR in the M memories MR. For example, the pixel group data PGD0 of N channels arranged at the same pixel position are stored in the same memory MR[0].

Therefore, as described in FIG. 3, when the pixel group data PGD of N channels stored in the SPM 16 is inputted to the line buffer 27, the same memory MR needs to be read-accessed in a time-division manner. Further, when the pixel data PDo of N channels arranged at the same pixel position and obtained by a plurality of multiply-accumulation calculators MAC or the like, are outputted to the SPM 16, the same memory MR needs to be write-accessed in a time-division manner. Therefore, the input/output latency between the SPM 16 and the NNE 15, in particular the MAC unit 25, is increased, and there is a possibility that the processing times of the image processing cannot be sufficiently shortened.

Here, for example, Resnet50, which is a widely known neural network model, has 50 layers. In the upstream intermediate layers, Nᵢ (number of input channels)=64, Nₒ (number of output channels)=256, W (X-size)=112, H (Y size)=112, N_{kw} (X-direction kernel size)=1, and Nₖₕ (Y-direction kernel size)=1 are used. When these are applied to the above-described Expression (1), 205, 520, 896 (=64×256×112×112×1×1) multiply-accumulate operations are required. Therefore, it is desired to increase the degree of parallelism of the multiply-accumulation calculators MAC.

For example, the degree of parallelism in the input channel, the output channel, the X-direction pixel, the Y-direction pixel, the X-direction kernel, or the Y-direction kernel depends on the architecture. However, considering that raster processing is a general hardware processing, it is an important requirement of hardware to increase the degree of parallelism in the channel direction. In particular, when the degree of parallelism in the channel direction is increased, since the input/output latency between the SPM 16 and the NNE 15 greatly affects the effective performance, a technique for reducing the input/output latency is required.

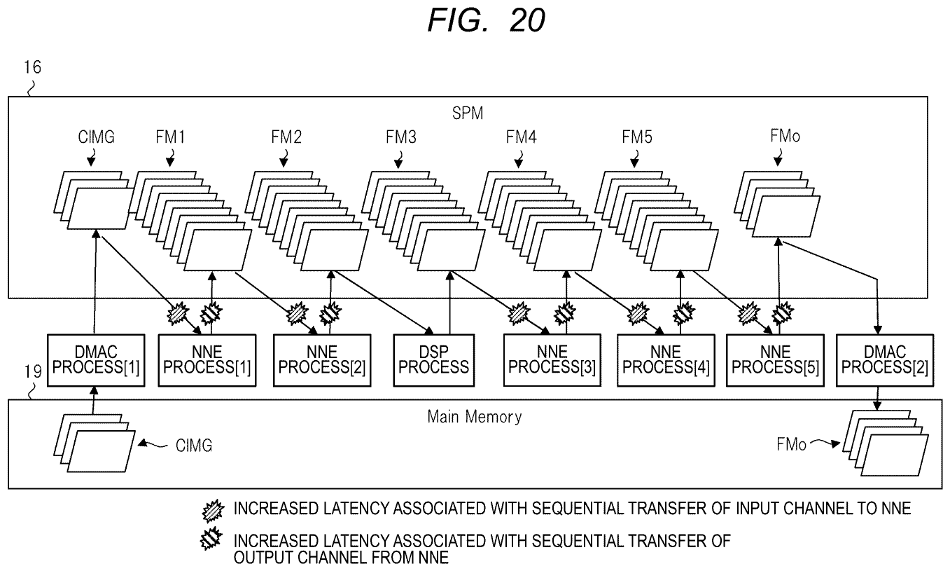

FIG. 20 is a schematic diagram for explaining the influence of the input/output latency occurring in the entire image processing using the neural network on the premise that the memory map shown in FIG. 19 is used. FIG. 20 shows a schematic process of the semiconductor device in which the neural network shown in FIG. 2 having five intermediate layers is a process target. In this case, semiconductor device sequentially executes DMAC process [1], NNE process [1], NNE process [2], DSP process, NNE process [3] to NNE process [5], and DMAC process [2]. The DMAC process [1] is a process related to the input layer, the NNE process [1] to NNE process [4] and DSP process are processes related to the intermediate layers, and the NNE process [5] and DMAC process [2] are processes related to the output layer.

In the DMAC process [1], the DMAC 17 transfers the camera image CIMG stored in the main memory 19 to the SPM 16. In the NNE process [1], the NNE 15 receives the camera image CIMG stored in the SPM 16 and performs signal processing, thereby generating the feature map FM1 and outputting the feature map FM1 to the SPM 16. In the NNE process [2], the NNE 15 receives the feature map FM1 stored in the SPM 16 and performs signal processing, thereby generating the feature map FM2 and outputting the feature map FM2 to the SPM 16.

In the DSP process, the DSP 18 receives the feature map FM2 stored in the SPM 16 and performs signal processing, thereby generating feature map FM3 and outputting the feature map FM3 to the SPM 16. From NNE process [3] to NNE process [5], the NNE 15 receives the feature map FM of the intermediate layer in the previous stage stored in the SPM 16 and performs signal processing, thereby generating feature map FM of the intermediate layer in the subsequent stage, and outputting the generated feature map FM to the SPM 16. In the DMAC process [2], the DMAC 17 transfers the feature map FMo of the output layer stored in the SPM 16 to the main memory 19.

When such processes are performed, the memory map shown in FIG. 19 is used, input/output latency related to input/output from the NNE process [1] to the NNE process [5] increases. Also, in the DSP process, the input/output latency is increased depending on the content of the process. As a result, the effective performance with respect to the theoretical performance is greatly reduced, and the processing time of the image processing using the neural network may be increased.

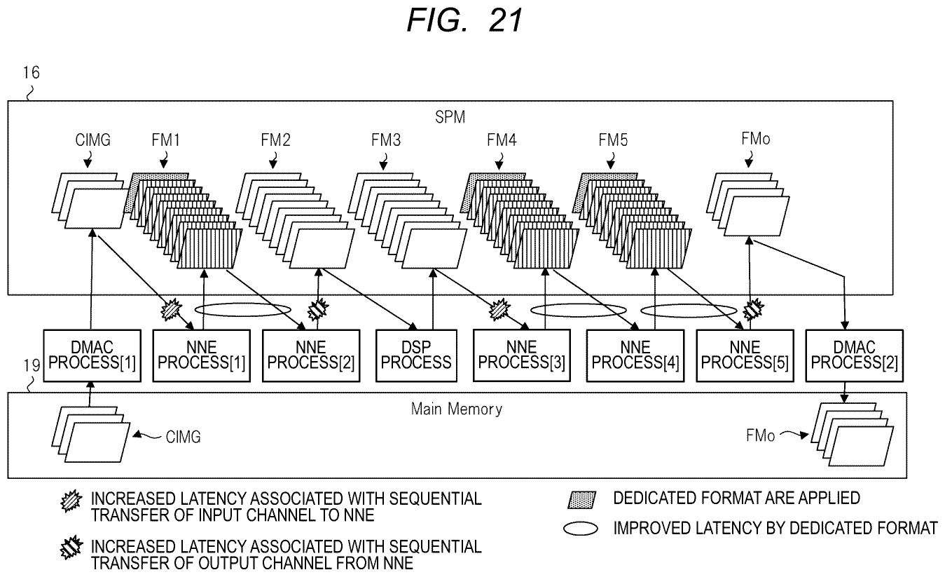

FIG. 21 is a schematic diagram for explaining an influence of input/output latency occurring in an entire image processing using a neural network in a semiconductor device as a second comparative example. In order to reduce the input/output latency described in FIG. 20, it is conceivable to apply a dedicated data format, for example, by integrating a plurality of channels, for the data transfer between the SPM 16 and the NNE 15. Specifically, as shown in FIG. 21, the dedicated data format is applied to the feature map FM1, FM4 and FM5 stored in the SPM 16.

However, general-purpose signal processing circuits such as the DSP 18 and the DMAC 17 cannot support the dedicated data format, and need to use general-purpose format such as Planar format shown in FIG. 19. Therefore, as shown in FIG. 21, even when the dedicated data format is used, the input/output latency is still increased at the time of inputting in the NNE process [1] and the NNE process [3] and at the time of outputting in the NNE process [2] and the NNE process [5]. As a result, there is a possibility that the processing time of the image processing cannot be sufficiently shortened.

### Memory Controller

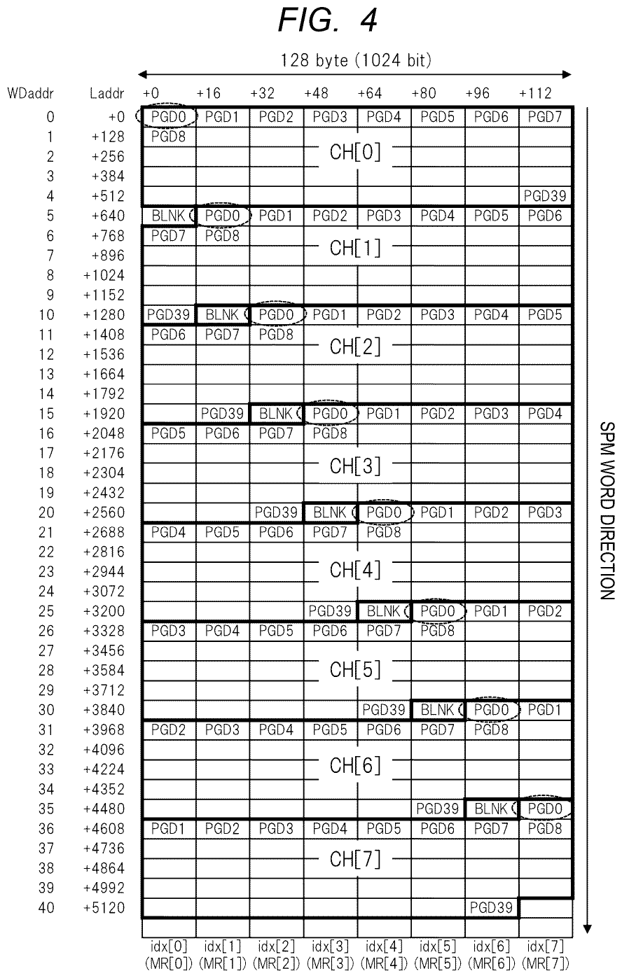

Accordingly, the memory controller 29 shown in FIG. 1 operates as follows. FIG. 4 is a diagram for explaining an operation example of the memory controller in FIG. 1 and is a diagram illustrating an example of a memory map of image data of respective channels stored in the scratchpad memory (SPM). The memory controller 29 controls the accessing of the SPM 16 such that the pixel group data PGD of the N channels arranged at the same pixel position and thus the pixel data PD in the image data DT of the N channels are respectively stored in different memory MR in the M memories MR[0] to MR[M-1].

In the case of FIG. 4, as in the case of FIG. 19, the SPM 16 has eight memories MR[0] to MR[7], and the respective memory MR have a bit-width of 16 bytes (=128 bits). In addition, as in FIG. 19, the size of the image data DT of one channel is 640 bytes (=64 bytes/row×10 row). The SPM 16 stores image data DT of eight channels CH[0] to CH[7] according to Planar format.

However, in the case of FIG. 4, unlike the case of FIG. 19, a blank area BLNK is provided between the storage area of the last pixel group data PGD39 in one channel and the storage area of the first pixel group data PGD0 in another channel in two adjacent channels. In this case, size of the blank area BLNK is 16 bytes. The memory controller 29 defines, for example, a start address for each of the eight channels CH[0] to CH[7], that is, an address of a storage area of the first pixel group data PGD0, so that such a blank area BLNK is provided.

Thus, for example, the first pixel group data PGD0 in the eight channels CH[0] to CH[7] are stored in the eight memories MR[0] to MR[7]. The same applies to the remaining pixel group data PGD, for example, the last pixel group data PGD39 in the eight channels CH[0], CH[1] to CH[7] are stored in the memories MR[7], MR[0] to MR[6], respectively.

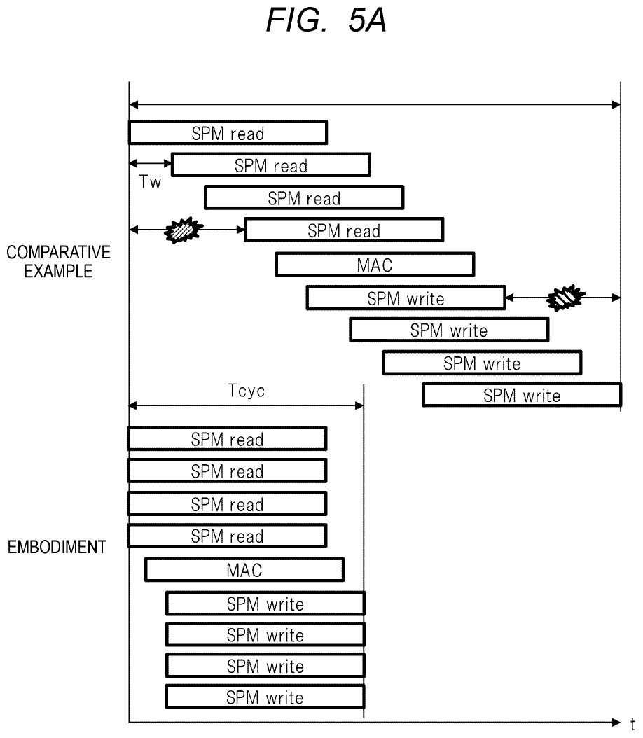

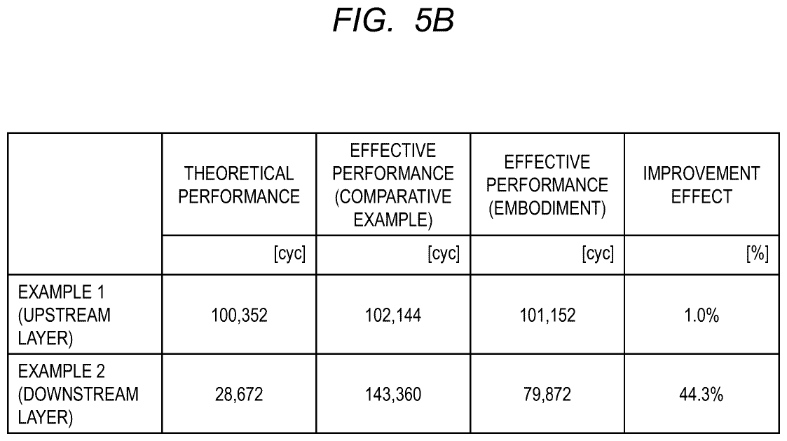

FIG. 5A shows a timing chart in which a schematic operation example of the neural network engine (NNE) in FIG. 1 is compared with a case in which the system of the first comparative example is used and a case in which the system of the embodiment is used. FIG. 5B is a diagram illustrating an example of a case in which the number of clock cycles required for the process of the convolution layer of one layer is compared between the case in which the method of the first comparative example is used and the case in which the method of the embodiment is used.

The neural network engine (NNE) 15 repeatedly performs a process cycling Tcyc as shown in FIG. 5A to process, for example, a layer of convolution layers. In this instance, when the first comparative example, that is, the memory map as shown in FIG. 19 is applied, the pixel group data PGD at the same pixel position in each channel needs to be read out from the same memory MR and needs to be written in the same memory MR after the multiply-accumulation operation by the multiply-accumulation calculators MAC. Therefore, the SPM 16 needs to perform a time-division read operation and a time-division write operation while providing a wait period Tw every time a read target or a write target channel is switched.

On the other hand, when the embodiment, that is, the memory map as shown in FIG. 4 is applied, the pixel group data PGD at the same pixel position in each channel can be read out from different memory MR, and can be written into different memory MR after the multiply-accumulation operation by the multiply-accumulation calculators MAC. Therefore, unlike the first comparative example, there is no need to provide the wait time Tw. In other words, the pixel group data PGD at the same pixel position can be simultaneously read from and written to the memories MR that differ from each other. As a result, the input/output latency can be shortened.

Here, as a specific example, it is assumed that MAC unit 25 can process 32 input channels and 32 output channels in one clock cycle, and can process two pixels in the X-direction within the clock cycle, that is, can perform 2048 (=32×32×2) convolution operations in parallel in one clock cycle. The latency excluding the input and output of the channel is assumed to be 50 clock cycles. In FIG. 5B, the number of clock cycles required for the process of one convolution layer is compared between the first comparative example and the embodiment on the premise that MAC unit 25 is used.

For example, in a typical network model of CNN such as Resnet50, in upstream convolution layers, that is, in upstream layers, the X/Y size of the image data DT is large. As processing proceeds downstream layers, the number of channels of the image data DT increases while the X/Y size of the image data DT decreases. In Example 1 shown in FIG. 5B, which is assumed to be the upstream layer case, W (X-size)=112, H (Y-size)=112, Nᵢ (number of input channels)=64, Nₒ (number of output channels)=256, N_{kw} (kernel X-size)=1, and Nₖₕ (kernel Y-size)=1 are used. In Example 2, which is assumed to be the downstream layer case, W=7, H=7, and Nᵢ=512, Nₒ=2048, N_{kw}=1, Nₖₕ=1 are used.

Further, in FIG. 5B, the theoretical performance TP is calculated by Expression (3). The effective performance AP_C according to method of the first comparative example is calculated by Expression (4). The effective performance AP_E according to method of the embodiment is calculated by Expression (5). Note that CEIL() is a function that rounds up the value in parentheses to an integral number.

$$TP = ( {N}_{i} / 32 ) \times ( {N}_{o} / 32 ) \times CEIL ( W / 2 ) \times H \qquad ( 3 )$$

$$AP\_C = ( {N}_{i} / 32 ) \times ( {N}_{o} / 32 ) \times \{ ( CEIL ( W / 2 ) \times H ) + 50 + ( 32 - 1 ) + ( 32 - 1 ) \} \qquad ( 4 )$$

$$AP\_E = ( {N}_{i} / 32 ) \times ( {N}_{o} / 32 ) \times \{ ( CEIL ( W / 2 ) \times H ) + 50 \} \qquad ( 5 )$$

Here, in one processing cycle Tcyc shown in FIG. 5A and FIG. 5B, the MAC unit 25 performs 2048 convolution operations within one clock cycle, and processes the image data DT of 32 input channels and the image data DT of 32 output channels using CEIL(W/2)×H clock cycles. For example, in Example 1, since Nᵢ (number of input channels)=64 and Nₒ (number of output channels)=256, the number of process cycle Tcyc required to process the image data DT of all input channels and the image data DT of all output channels is 16 (=64/32×256/32).

In Expressions (4) and (5), an overhead of (Nᵢ/32)×(Nₒ/32)×{(32−1)+(32−1)} is added to the effective performance AP_C according to the method of the first comparative example as compared with the effective performance AP_E according to the method of the embodiment. That is, in FIG. 5A, the overhead associated with 32 channels-1 clock cycles is added at the time of inputting and outputting for each process cycle Tcyc with the wait period Tw being set as one clock cycle. The number of processing cycles Tcyc required for processing the convolution layers increases as the number of channels increases. Therefore, in the method of the first comparative example, in particular, the deviation of the effective performance AP_C with respect to the theoretical performance TP becomes larger in the downstream layers. When the method of the embodiment is used, this deviation can be suppressed. In particular, an improvement effect of 44.3% (=1−(79, 872/143, 360)) in the downstream layer can be obtained.

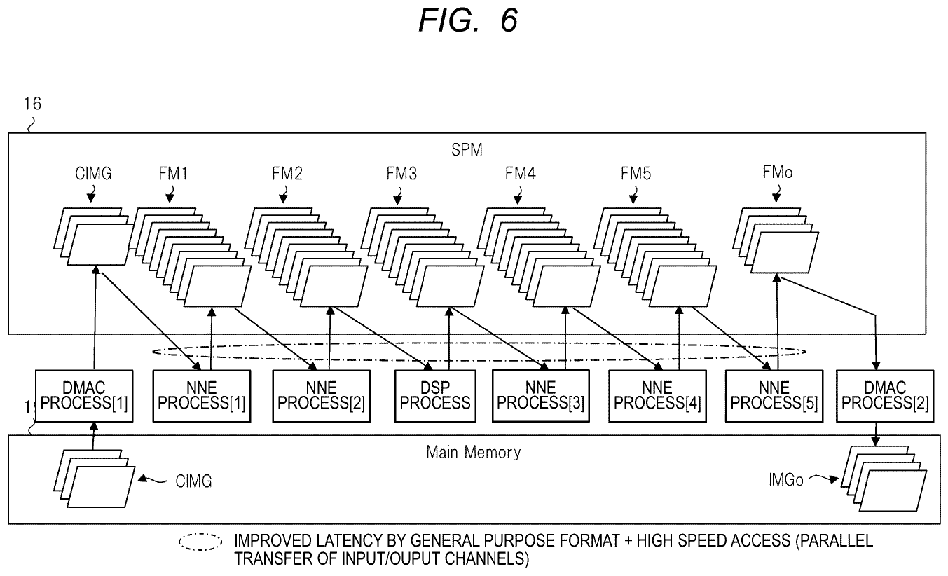

FIG. 6 is a schematic diagram for explaining the influence of the input/output latency occurring in the entire image processing using the neural network on the premise that the memory map shown in FIG. 4 is used. Using the method of the embodiment, unlike in FIG. 20 or FIG. 21, as shown in FIG. 6, the input/output latency can be reduced from the NNE process [1] to the NNE process [5] and all the input/output associated with the DSP process. In this case, since Planar format, which is a general-purpose format, is used instead of the dedicated data format, the input/output latency can be shortened even when the DSP process is included in particular.

### Configuration of SPM and Blank Area

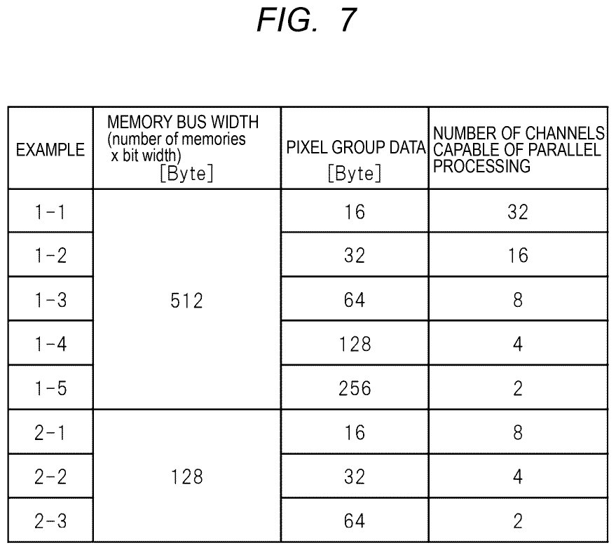

FIG. 7 is a diagram illustrating various exemplary configurations of the scratchpad memory (SPM) in FIG. 1. The SPM 16 includes, for example, a 2^{m} (=M) number of memories MR where m is an integer of 1 or more. The bit-width of the respective memory MR is, for example, 2^{k} bytes, where k is an integer of 0 or more. Here, it is assumed that the size FS of the image data for each channel is GS×even number, where GS is the size of the pixel group data PGD.

Examples 1-1 to 1-5 shown in FIG. 7 show examples in which 32 (=2⁵) memories MR each having a bit width of 16 bytes are provided to configure the SPM 16 having a memory bus width of 512 bytes. In Example 1-1, a size GS of the pixel group data PGD is 16 bytes, and one pixel group data PGD is stored in one memory MR. In this case, when the same method as in the case of FIG. 4 is used, the number of input channels or the number of output channels capable of parallel processing is 32 (=512/16).

In addition, the size of the respective blank areas BLNK may be 16-byte×(a number that is prime to 32 channels), that is, 16-byte×odd number, in units of 16-byte, which is the size GS of the pixel group data PGD. In addition, from the viewpoint of making the size of the blank area BLNK as small as possible, that is, saving memories, it is desirable that the size of the blank area BLNK is 16-byte×1.

In Example 1-2, a size GS of the pixel group data PGD is 32 bytes, and one pixel group data PGD is stored in two memory MR. In this case, when the same method as in the case of FIG. 4 is used, the number of input channels or the number of output channels in which parallel processing can be performed is 16 (=512/32). In addition, the size of the respective blank areas BLNK may be 32-byte×(number which is prime with respect to 16 which is the number of channels), that is, 32-byte×odd number in units of 32-byte which is the size GS of the pixel group data PGD, and preferably 32-byte×1 among them.

In Example 1-3, a size GS of the pixel group data PGD is 64 bytes, and one pixel group data PGD is stored in four memory MR. In this case, when the same method as in the case of FIG. 4 is used, the number of input channels or the number of output channels in which parallel processing can be performed is 8 (=512/64). Further, the size of the respective blank areas BLNK may be 64-byte×(number which is prime to 8 which is the number of channels), that is, 64-byte×odd number in units of 64-byte which is the size GS of the pixel group data PGD, and preferably 64-byte×1 among them.

Similarly, in Example 1-4, the size GS is 128 bytes, and the number of input/output channels that can be processed in parallel is 4 (=512/128). The size of the respective blank areas BLNK may be 128-byte×(a number that is prime to 4 which is the number of channels), that is, 128-byte×odd number, and preferably 128-byte×1 among them. In Examples 1-5, the size GS is 256 bytes, and the number of input/output channels that can be processed in parallel is 2 (=512/256). The size of the blank area BLNK may be 256-byte×(a number that is prime to 2, which is the number of channels), that is, 128-byte×odd number, and consequently 128-byte×1.

Examples 2-1 to 2-3 in FIG. 7 show an example in which 8 (=2³) memory MR having a bit width of 16 bytes are provided to configure the SPM 16 having a memory bus width of 128 bytes. In Example 2-1, a size GS of the pixel group data PGD is 16 bytes, and one pixel group data PGD is stored in one memory MR. That is, Example 2-1 corresponds to the configuration shown in FIG. 4. The number of input channels or output channels that can be processed in parallel is 8 (=128/16). In addition, the size of the respective blank areas BLNK may be 16-byte×(the number that is prime to 8 which is the number of channels), that is, 16-byte×odd number, and, preferably 16 byte×1 among them.

Similarly, in Example 2-2, the size GS is 32 bytes, and the number of input/output channels that can be processed in parallel is 4 (=128/32). The size of the blank area BLNK may be 32-byte×(a number that is prime to 4 which is the number of channels), that is, 32-byte×odd number, and preferably 32-byte×1 among them. In Example 2-3, the size GS is 64 bytes, and the number of input/output channels that can be processed in parallel is 2 (=128/64). The size of the blank area BLNK may be 64-byte×(a number that is prime with respect to 2, which is the number of channels), that is, 64-byte×odd number, and consequently 64-byte×1.

When the above is generalized, assuming the SPM 16 including M (=2^{m}) memories MR composed of K (=2^{k}) bytes, the size GS of the pixel group data PGD is determined to be 2^{(k+a)} bytes, and the number N of channels to be processed in parallel is determined to be 2^{(m-a)}. In addition, the blank area BLNK is defined as 2^{(k+a)}-byte×(the number that is prime with respect to 2^{(m-a)} that is the number of channels). Note that a is an integer of 0 or more and less than m. Further, the generalized logical address Laddr of the SPM 16 is given by Expression (6). As in Expression (2), WDaddr is the word address of each memory MR, and idx is the identification number of each memory MR.

$$Laddr = WDaddr \times ( M \times K ) + ( idx \times K ) \qquad ( 6 )$$

For example, referring to Example 2-1 of FIG. 7 and FIG. 4, K (=2^{k}) is 16 (=2⁴) bytes, M (=2^{m}) is 8 (=2³), GS is 16 (=2⁽⁴⁺⁰⁾) bytes, and N is 8 (=2⁽³⁻⁰⁾). In addition, the blank area BINK is set to 16 (=2⁽⁴⁺⁰⁾×1).

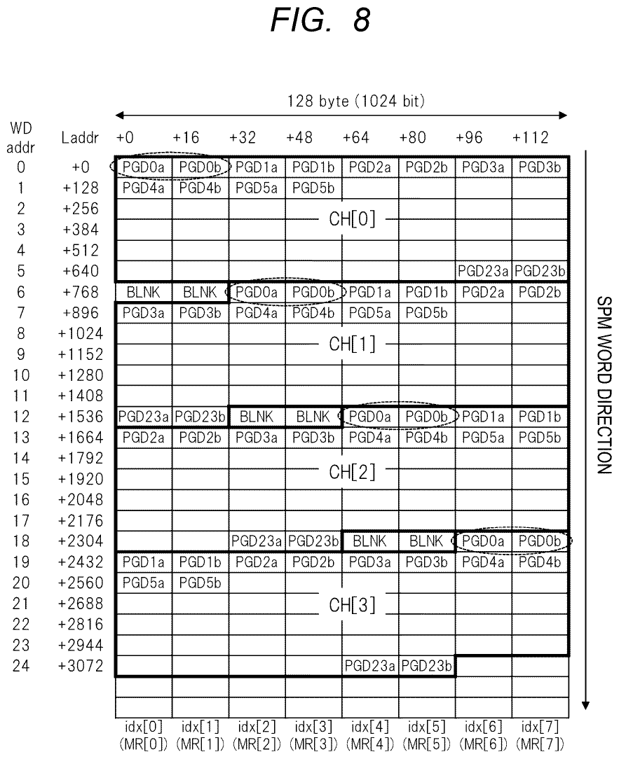

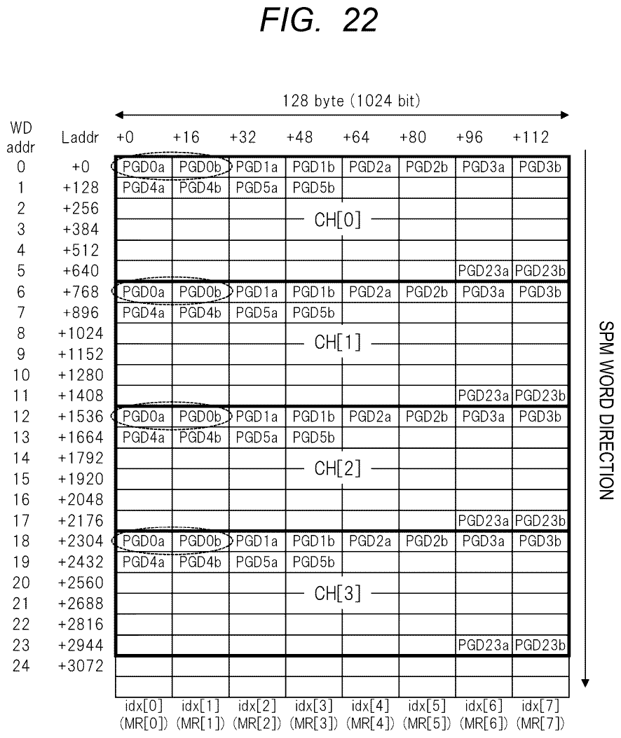

FIG. 8 is a diagram illustrating an example of a memory map different from that illustrated in FIG. 4, which corresponds to Example 2-2 in FIG. 7. FIG. 22 is a diagram illustrating an example of a memory map as a comparative example of FIG. 8. In the cases shown in FIGS. 8 and 22, the SPM 16 has eight memories MR[0] to MR[7]. Each memory MR has a bit width of 16 bytes. That is, the memory bus width of the SPM 16 is 128 bytes (=16-byte×8). The size GS of pixel group data PGD is 32 bytes.

Here, the size of the image data of one channel is 768 bytes consisting of 96-byte/row×8 rows in a raster structure. In this case, when the method of the comparative example is used, the memory map as shown in FIG. 22 is formed. In FIG. 22, the plurality of pixel group data PGD0a, PGD0b, PGD1a, PGD1b, PGD2a, PGD2b correspond to the data of the first row in the raster structure, and the plurality of pixel group data PGD3a, PGD3b, PGD4a, PGD4b, PGD5a, PGD5b correspond to the data of the second row in the raster structure. The number of channels of the image data is 4.

As shown in FIG. 22, in the method of the comparative example, as in the case of FIG. 19, the pixel group data PGD of the four channels CH[0] to CH[3] arranged at the same pixel position, for example, the pixel group data PGD0a, PGD0b of 32 bytes, are stored in the same memory pair (MR[0], MR[1]). On the other hand, in the method of the embodiment, as shown in FIG. 8, a 32-byte blank area BLNK is provided. As a result, the pixel group data PGD of the four channels CH[0] to CH[3] arranged at the same pixel position, for example, the pixel group data PGD0a, PGD0b of 32 bytes, are stored in memory pairs (MR[0], MR[1]), (MR[2], MR[3]), (MR[4], MR[5]), (MR[6], MR[7]) which differ from each other.

### Details of Main Part in Semiconductor Device

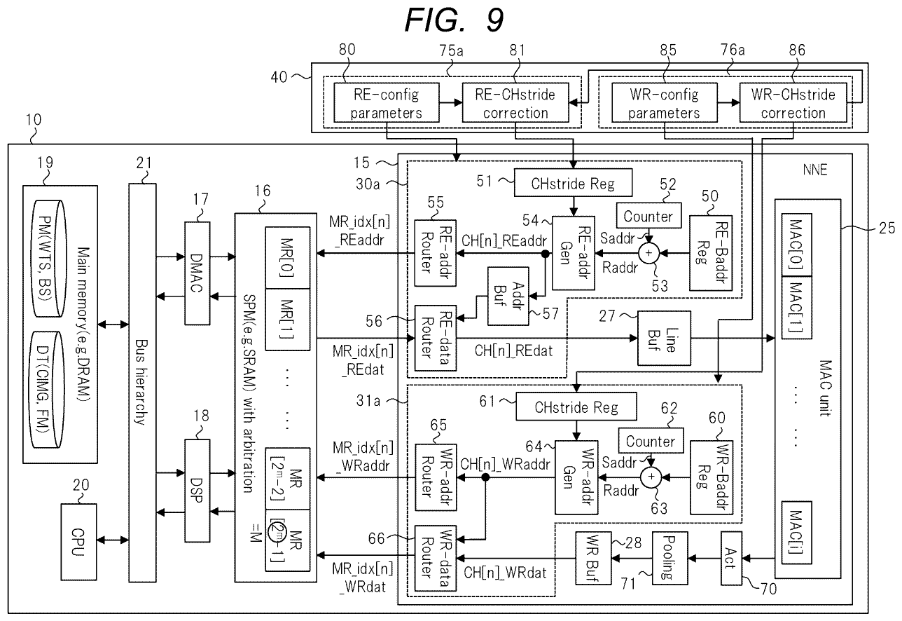

FIG. 9 is a block diagram illustrating a detailed configuration of a main part in semiconductor device illustrated in FIG. 1. FIG. 9 mainly shows a detailed configuration example of the memory controller 29 in FIG. 1 and a detailed configuration example of the neural network software system 40. As shown in FIG. 9, the SPM 16 may include, for example, an arbitration circuit that arbitrates a plurality of accesses to the same MR.

In addition, the activation function calculation unit 70 illustrated in FIG. 9 performs, for example, addition of the bias parameter BS and calculation of the activation function on the multiply-accumulation operation result from MAC unit 25. The pooling processing unit 71 performs pooling processing as necessary. The activation function calculation unit 70 and the pooling processing unit 71 are implemented in the post processor 26 in FIG. 1. Details of the memory controller 29 and the neural network software system 40 will be described below.

### Details of Memory Controller

In FIG. 9, the read access controller 30a and the write access controller 31a are included in the memory controller 29 in FIG. 1. The read access controller 30a includes a read base address register 50, a channel stride register 51, an address counter 52, an adder 53, a read address generator 54, a read address router 55, a read data router 56, and an outstanding address buffer 57.

In general, the read access controller 30a generates, in parallel, read logical addresses of N channels in which pixel data PD of N channels are stored, when the pixel group data PGD of the N channels and thus the pixel data PD are read from the SPM 16. Further, the read access controller 30a translates the generated read logical addresses of the N channels into read physical addresses of the M memories MRs in parallel, and outputs the read logical addresses to the SPM 16. Further, the read access controller 30a rearranges the pixel data PD of the N channels read from the SPM 16 in the order of the channels and outputs them in parallel to the MAC unit 25.

Specifically, in the read base address register 50 for read, the start address for reading the image data DT of the N channels stored in the SPM 16 is set as the base address. For example, in FIG. 4, the start address of the channel CH[0] is set. Typically, in the SPM 16, a read address space used for inputting to the MAC unit 25 and a write address space used for outputting from the MAC unit 25 are individually set. The read base address register 50 defines the position of the read address space in the SPM 16.

The address counter 52 generates scan address Saddr by sequentially counting from 0 in unit of the size GS of the pixel group data PGD. In the case of FIG. 4, 16 bytes is used as units. The adder 53 generates the reference logical address Raddr by adding the base address from the read base address register 50 and the scan address Saddr from the address counter 52. As a result, in the read address space, for example, the reference logical address Raddr is generated such that the pixel group data PGD of the channel CH[0] in FIG. 4 are sequentially scanned with PGD0, PGD1, . . . , PGD7, PGD8, . . . .

In the channel stride register 51 for read, the address spacing between neighboring channels of the respective start addresses of the image data DT of the N channels stored in the SPM 16 is set as a channel stride. For example, in FIG. 4, the address spacing between the logical address of the pixel group data PGD0 in the channel CH[0] and the logical address Laddr of the pixel group data PGD0 in the channel CH[1], specifically, 640+16 bytes is set.

The read address generator 54 adds an integral multiple of the address spacing set in the channel stride register 51 to the reference logical address Raddr inputted from the adder 53, thereby generating the read logical addresses CH[n]_REaddr of the N channels in parallel, in other words, in the same clock cycle. That is, the read address generator 54 generates the read logical addresses CH[0]_REaddr-CH[7]_REaddr of the N channels, in the case of FIG. 4, 8 channels, based on Expression (7). In Expression (7), CHstride is an address spacing set in the channel stride register 51, and n is an integer from 0 to N-1.

$$CH [ n ] \_REaddr = Raddr + CHstride \times n \qquad ( 7 )$$

Specifically, if N=8, CHstride=656 and Raddr=0, the read address generator 54 generates CH[0]_REaddr=0, CH[1]_REaddr=656, . . . , CH[7]_REaddr=4592 in parallel. Thus, in FIG. 4, the logical addresses Laddr of the pixel group data PGD0 in the eight channels CH[0] to CH[7] are generated in parallel.

The read address router 55 translates the read logical addresses CH[n]_REaddr of the N channels generated in parallel by the read address generator 54 in parallel to the read physical address MR_idx[n]_REaddr for the memory MR corresponding to each channel in the M memories MRS. The read address router 55 outputs the translated read physical address MR_idx[n]_REaddr in parallel to the corresponding memory MR for each channel. Details of the read address router 55 will be described later.

In response to the read physical address MR_idx[n]_REaddr from the read address router 55, the read data router 56 rearranges the pixel data PD of the N channels read from the memory MR corresponding to each channel, detail, the memory read data MR_idx[n]_REdat arranged in the memory order, in the channel order. The outstanding address buffer 57 is provided for performing the rearrangement in the read operation.

The read data router 56 outputs the channel read data CH[n]_REdat obtained by the rearrangement to the MAC unit 25 in parallel. Specifically, the read data router 56 stores the channel read data CH[n]_REdat in parallel in the line buffer 27 having the storage area in the order of the channels, and outputs the data to MAC unit 25 via the line buffer 27. Details of the read data router 56 and the outstanding address buffer 57 will be described later.

The write access controller 31a includes a write base address register 60, a channel stride register 61, an address counter 62, an adder 63, an write address generator 64, an write address router 65, and a write data router 66. The operations of the write base address register 60, the channel stride register 61, the address counter 62, the adder 63, and the write address generator 64 are the same as those of the read base address register 50, the channel stride register 51, the address counter 52, the adder 53, and the read address generator 54 described above.

Thus, the write access controller 31a generates in parallel write logical addresses of N channels for storing pixel data PD of N channels, respectively, when the pixel group data PGD of N channels obtained based on the multiply-accumulation operation performed by the MAC unit 25 and thus the pixel data PD are written to the SPM 16. In addition, the write access controller 31a translates the generated write logical addresses of the N channels in parallel to the write physical addresses of the corresponding memory MR for each channel. Then, the write access controller 31a outputs the write physical addresses in parallel to the memories MR corresponding to each channel, together with the pixel data PD of the N channels obtained based on the multiply-accumulation operation performed by the MAC unit 25.

At this time, the write address router 65 translates the write logical address CH[n]_WRaddr of the N channels generated in parallel by the write address generator 64 into the write physical address MR_idx[n]_WRaddr for the memory MR corresponding to each channel in the M memories MRs in parallel. Then, the write address router 65 outputs the translated write physical address MR_idx[n]_WRaddr in parallel to the corresponding memory MR for each channel. Details of the write address router 65 will be described later.

On the other hand, the write data router 66 outputs the pixel data PD of the N channels obtained based on the multiply-accumulation operation performed by the MAC unit 25, detail, the channel write data CH[n]_WRdat stored in the write buffer 28 having the storage area in the order of the channels, in parallel to the corresponding memory MR for each channel. At this time, the write data router 66 rearranges the channel write data CH[n]_WRdat arranged in the channel order in the memory order. Then, the write data router 66 outputs the memory write data MR_idx[n]_WRdat obtained by the rearrangement to the memory MR corresponding to each channel. Details of the write data router 66 will be described later.

### Details of Address Router

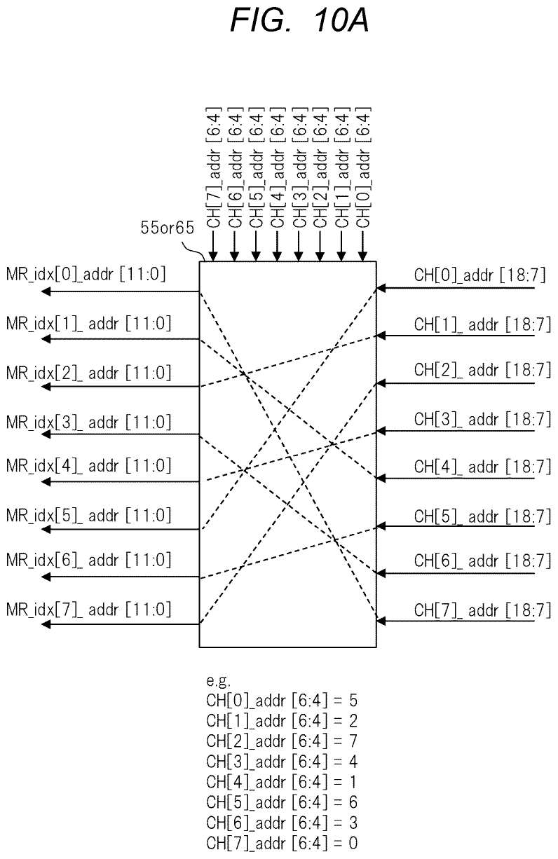

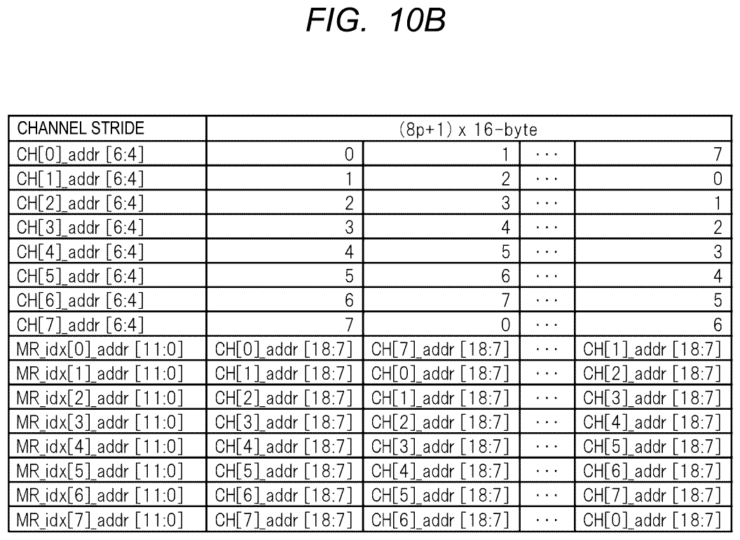

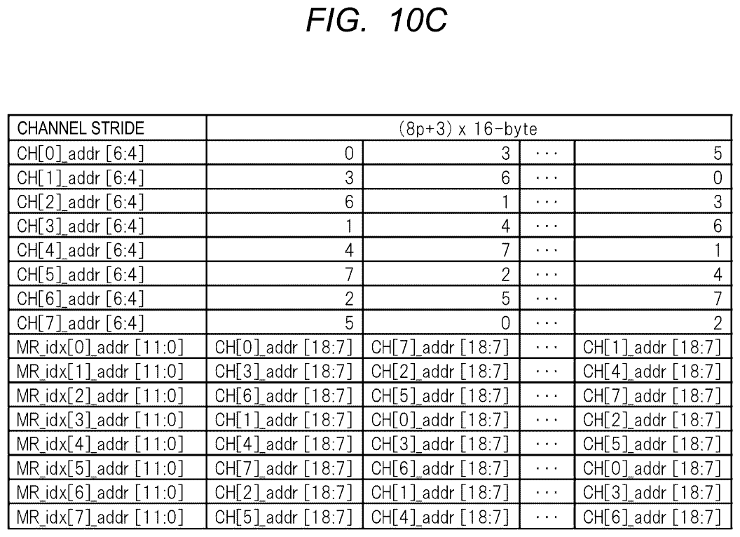

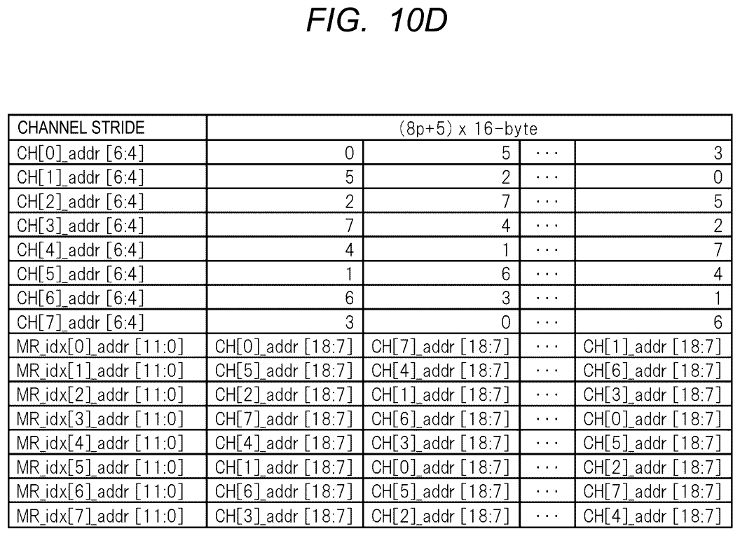

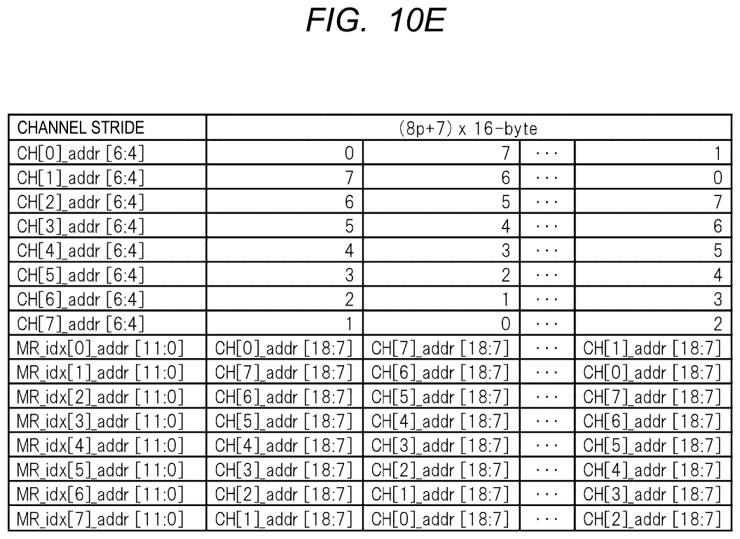

FIG. 10A is a schematic diagram illustrating a configuration example of an address router and a partial operation example of the address router shown in FIG. 9. From FIG. 10B to FIG. 10E are diagrams for describing the operations of the address routers shown in FIG. 10A. The address router shown in 10A corresponds to the read address router 55 or the write address router 65. Here, it is assumed that the SPM 16 includes eight memories MR[0] to MR[7] each having 64k bytes. With this configuration, the SPM 16 has a capacity of 512k byte. It is assumed that the respective memories MR have 4096 word addresses WDaddr and a bit width of 16 bytes. That is, for example, it is assumed that WDaddr of word addresses is 4096 in Example 2-1 shown FIG. 7 and FIG. 4.

The address router receives the logical addresses CH[0]_addr[18:4] to CH[7]_addr[18:4] of the eight channels CH[0] to CH[7] from the address generators 54, 64 in parallel. In the case of the read address router 55, the logical address CH[n]_addr corresponds to the lead logical address CH[n]_REaddr. In the case of the write address router 65, the logical address CH[n]_addr corresponds to the write logical address CH[n]_WRaddr.

The address router outputs the physical addresses MR_idx[0]_addr[11:0] to MR_idx[7]_addr[11:0] of the eight memories MR[0] to MR[7] in parallel. In the case of the read address router 55, the physical address MR_idx[n]_addr corresponds to the read physical address MR_idx[n]_REaddr. In the case of the write address router 65, the physical address MR_idx[n]_addr corresponds to the write physical address MR_idx[n]_WRaddr. Specifically, the physical address MR_idx[n]_addr corresponds to, for example, the word address WDaddr in FIG. 4.

In this case, since access is performed in units of 16 bytes, the lower 4 bits ([3:0]) in the logical address CH[n]_addr are fixed to 0. Accordingly, the fourth to eighteenth bits ([18:4]) of the logical address CH[n]_addr are inputted to the address router. The eight memories MR[0] to MR[7] correspond to the eight index idx[0] to idx[7], respectively. The eight index idx[0] to idx[7] are assigned to the fourth to sixth bit ([6:4]) which is low-order side bits in the logical address CH[n]_addr. Thus, the logical address CH[n]_addr[6:4] can identify the correspondence between the channels and the memory MR.

Here, for example, a read operation from the SPM 16 at a certain process cycle Tcyc[t] is assumed. At this time, the logical address CH[0]_addr[18:4] to CH[7]_addr[18:4] of the eight channels inputted in parallel to the address router differ from each other in the fourth to sixth bits ([6:4]) depending on the operation of the read address generator 54 based on the channel stride register 51. The address router identifies the memory MR corresponding to each channel by the logical addresses CH[0]_addr-CH [7]_addr of the eight channels, which is a particular bit area, in this case, from the fourth bit to the sixth bit ([6:4]).

In the embodiment shown in FIG. 10A, the logical address CH[n]_addr [6:4] of the channel CH[n] represents the index idx[5], [2], [7], [4], [1], [6], [3], [0], and thus the memory MR[5], [2], [7], [4], [1], [6], [3], and [0], respectively, when n=0, 1, 2, 3, 4, 5, 6, 7. That is, here, unlike the case of FIG. 4, a case is shown in which the size of the image data DT of one channel is (8 p+4)×16 bytes where p is an integral number. That is, in FIG. 4, the respective channels CH[0] to CH[7] are configured by, for example, pixel group data PGD0-PGD43. In FIG. 4, the size of the image data DT of one channel is (8 p+0)×16 bytes.

Alternatively, FIG. 10A shows the case where the size of the image data DT of one channel is (8 p+5)×16 byte and the channel stride (CHstride) is also set to (8 p+5)×16 bytes. The blank area BLNK is then not provided. That is, if the size of the image data DT of one channel is (8 p+odd number)×16 byte, the blank area BLNK is not required.

The address router identifies a memory MR[q] to be an output destination of the bit area from the 7th bit to the 18th bit ([18:7]), which is bits on high-order side of the logical address CH[n]_addr[18:4] by using index value (idx) indicated by the 4th to 6th bits ([6:4]) of the logical address CH[n]_addr. Then, the address router outputs the logical address CH[n]_addr[18:7] of the channel CH[n], which is the bit area to be output, to the memory MR[q] identified by the index value (idx) as the physical address MR_idx[q]_addr[11:0] of 12 bits.

With such an operation, in the embodiment shown in FIG. 10A, the logical address CH[0]_addr[18:7] of the channel CH[0] is outputted to the memory MR[5] as the physical address MR_ idx[5]_addr[11:0] because the index value (idx) is 5. The logical address CH[1]_addr[18:7] of the channel CH[1] is outputted to the memory MR[2] as the physical address MR_idx[2]_addr[11:0] because the index value (idx) is 2. The same applies to the remaining channels CH[2] to CH[7].

In the read operation from the SPM 16 in the subsequent process cycle Tcyc[t+1], the index value (idx) of the fourth to sixth bits ([6:4]) are incremented by +1 by the operation of the address counter 52. Consequently, the output destinations of the logical address CH[n]_addr[18:7] of channels[0], [1], [2], [3], [4], [5], [6], and [7] are switched to the memory MR[6], [3], [0], [5], [2], [7], [4], and [1], respectively. That is, referring to FIG. 4, for example, in a certain processing cycle, the pixel group data PGD of the channel CH[0] is read from the word address “A” of the memory MR[5], and in the next processing cycle, the next pixel group data PGD of the channel CH[0] is read from the same word address “A” of the different memory MR[6].

Specifically, the address router includes, for example, a selector, a matrix switch, or the like that determines a connection-relationship between the input signals of the N channels and the output signals to the M memories MR. In this example, the input signal is logical address CH[n]_addr[18:7] of eight channels which is the bit area of the logical address. The output is the physical address MR_idx[n]_addr[11:0] to the eight memories MR.

The logical address CH[n]_addr[6:4] of the eight channels which is the other bit area of the logical address is used as a selection signal of the selector or the matrix switch. With such a configuration, the address router can process the input signals of the N channels in parallel, in other words, in one clock cycle, and output the processed signals in parallel as output signals to the M memories MR. As a result, the input/output latency can be shortened.

In an operation example shown in FIG. 10B, the size of the image data DT of one channel is (8 p+0)×16 bytes, where p is an integral number, and the channel stride (CHstride) is set to (8 p+1)×16 bytes accordingly. That is, the operation example when a blank area BLNK of 16-byte×1 is provided at a place as shown in FIG. 4 is shown. Alternatively, an operation example is shown when the size of the image data DT of one channel is (8 p+1)×16 bytes and the channel stride (CHstride) is also set to (8 p+1)×16 bytes. That is, in FIG. 4, the operation example in which the respective channels CH[0] to CH[7] are configured by, for example, the pixel group data PGD0 to PGD40 and the like, and the blank area BLNK is not required is shown.

In an operation example shown in FIG. 10C, the size of the image data DT of one channel is (8 p+2)×16 bytes, and the channel stride (CHstride) is correspondingly set to (8 p+3)×16 bytes. That is, in FIG. 4, the operation example in which the respective channels CH[0] to CH[7] are configured by, for example, the pixel group data PGD0-PGD41 and the like, and accordingly, the blank area BLNK of 16-byte×1 is provided. Alternatively, an exemplary operation is shown in a case where the size of the image data DT of one channel is (8 p+3)×16 bytes, and the channel stride (CHstride) is also set to (8 p+3)×16 bytes, that is, in a case where the blank area BLNK is not required.

Similarly, FIG. 10D shows an operation example when DT is (8 p+4)×16 bytes and the channel stride (CHstride) is set to (8 p+5)×16 bytes. Alternatively, an operation example when DT is (8 p+5)×16 bytes is shown. In an operation example shown in FIG. 10E, the image data DT is (8 p+6)×16 bytes, and the channel stride (CHstride) is set to (8 p+7)×16 bytes. Alternatively, an operation example when DT is (8 p+7)×16 bytes is shown. Note that the connection-relationship between the input signals and the output signals illustrated in FIG, 10A represents a part of the operation illustrated in FIG. 10D.

Each of FIGS. 10B, 10C, 10D, and 10E shows a combination of index (idx) represented by logical addresses CH[n]_addr[6:4] of eight channels that are selection signals. Here, three combinations, i.e., combination for three columns, are shown with some omissions, but in detail, there are eight combinations. Each diagram shows which of the logical address CH[n]_addr[18:7] of the eight channels that are the input signals is connected to each of the eight physical addresses MR_idx[n]_addr[11:0] that are the output signals for each combination of the selection signals.

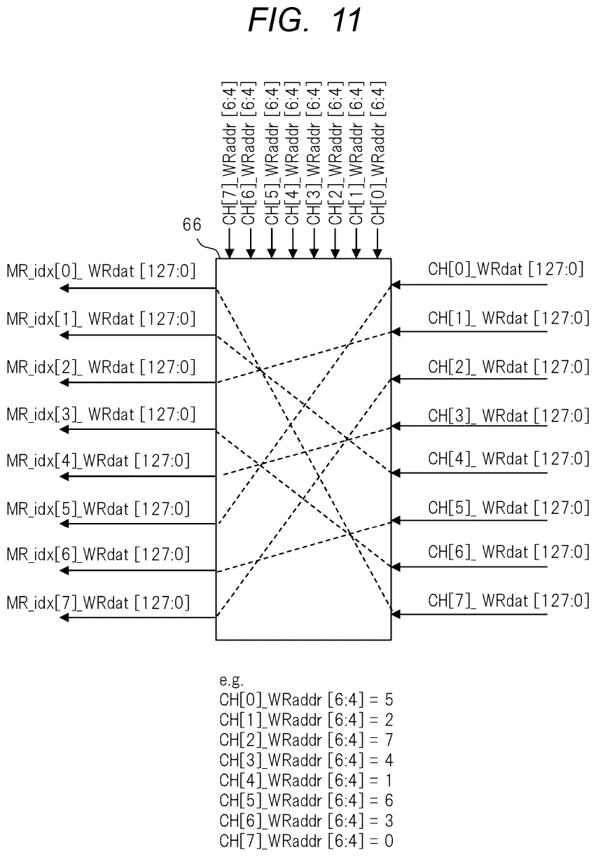

FIG. 11 is a schematic diagram illustrating a configuration example and a partial operation example of the data router for write in FIG. 9. The write data router 66 shown in FIG. 11 has the same configuration as that of the address router shown in FIG. 10A except that the input signals and the output signals differ from those in FIG. 10A, and performs the same operation. The input signals to the write data router 66 are the channel write data CH[n]_WRdat[127:0] of the eight channels outputted from the MAC unit 25 and stored in the write buffer 28 in the order of the channels through an operation such as an activation function. Each channel write data CH[n]_WRdat[127:0] is 16 bytes (=128 bits).

The output signals from the write data router 66 are eight memory write data MR_idx[n]_WRdat[127:0] arranged in memory order. The write data router 66 uses the same selection signal as in FIG. 10A, i.e., idx based on the write logical address CH[n]_WRaddr[6:4] of the eight channels from the write address generator 64, to define the connection-relationship between the input signals and the output signals. As a result, the memory MR for each channel identified by the write address router 65, that is, the correspondence between the channel and the memory MR, is the same as the memory MR for each channel identified by the write data router 66.

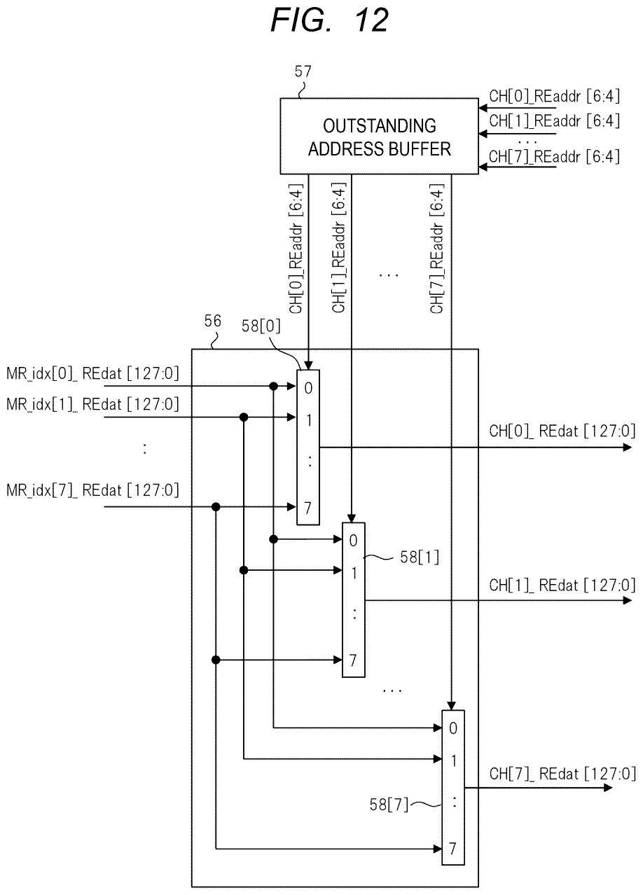

FIG. 12 is a schematic diagram illustrating a configuration example of a data router for reading in FIG. 9. The read data router 56 shown in FIG. 12 basically has the same configuration as the write data router 66 shown in FIG. 11, except that the direction of input and output is opposite to that of FIG. 11, and performs the same operation. The read data router 56 receives eight memory read data MR_idx[n]_REdat[127:0] which are read from eight memories MR and arranged in memory order. The size of each memory read data MR_idx[n]_REdat[127:0] is 16 bytes (=128 bits).

The read data router 56 outputs eight channel read data CH[n]_REdat[127:0] arranged in the order of the channels. The read data router 56 uses the same selection signal as in 10 A, i.e., idx based on the read logical address CH[n]_REaddr[6:4] of the eight channels from the read address generator 54 for read, to define the connection-relationship between the input signals and the output signals. As a result, the memory MR for each channel identified by the read address router 55, that is, the correspondence between the channel and the memory MR, is the same as the memory MR for each channel identified by the read data router 56.

However, in the read operation, the memory MR receives the physical address and outputs the memory read data with a read latency of a predetermined number of clocks. To compensate for this read latency, the outstanding address buffer 57 buffers a particular bit area ([6:4]) in the read logical address CH[n]_REaddr[18:4] of the eight channels from the read address generator 54 for a period based on the read latency. The outstanding address buffer 57 then outputs the buffered read logical address CH[n]_REaddr[6:4] to the read data router 56.

In FIG. 12, the read data router 56 includes eight selectors 58[0] to 58[7]. The selector 58[0] selects any one of the eight memory read data MR_idx[0]_REdat-MR_idx[7]_REdat based on the read logical address CH[0]_REaddr[6:4] of the channel CH[0], which is the selection signal of the channel CH[0]. Then, the selector 58[0] outputs the selected memory read data as the channel read data CH[0]_REdat of the channel CH[0].

Similarly, the selector 58[7] selects any one of the eight memory read data MR_idx[0]_REdat-MR_idx[7]_REdat based on the read logical address CH[7]_REaddr[6:4] of the channel CH[7], which is the selection signal of the channel CH[7]. Then, the selector 58[7] outputs the selected memory read data as the channel read data CH[7]_REdat of the channel CH[7]. The address routers 55 and 65 shown in FIG. 10A and the write data router 66 shown in FIG. 11 can also be realized with the same configuration by changing the input and output directions of the selectors.

### Details of Neural Network Software System

In FIG. 9, the neural network software system 40 includes a read control unit 75a and a write control unit 76a that are realized by the CPU 20 executing the neural network software. The read control unit 75a, that is, the CPU 20 mainly sets the setting value of each register included in the read access controller 30a as the read configuration parameter 80 and sets the setting value in each register. Here, the read control unit 75a includes a read channel stride correction unit 81. The read channel stride correction unit 81 corrects the channel stride for read (CHstride) included in the read configuration parameter 80 as needed, and sets the corrected channel stride in the channel stride register 51.

Similarly, the write control unit 76a, that is, CPU 20, mainly sets the setting values of the respective registers included in the write access controller 31a as the write configuration parameters 85 and sets the setting values in the respective registers. Here, the write control unit 76a includes a write channel stride correction unit 86. The write channel stride correction unit 86 corrects the write channel stride included in the write configuration parameter 85 as needed, and sets the correction channel stride (CHstride) in the write channel stride register 61.

The read channel stride correction unit 81 may set the corrected write channel stride (CHstride) obtained by the write channel stride correction unit 86 in the read channel stride register 51 as the corrected read channel stride (CHstride). That is, the channel stride (CHstride) used for write operation for a layer and the channel stride (CHstride) used for read operation for a subsequent layer are usually equal. For example, in FIG. 20, the channel stride (CHstride) used at the output of NNE process [1] and the channel stride (CHstride) used at the input of NNE process [2] are both channel strides (CHstride) applied to the same feature map FM1.

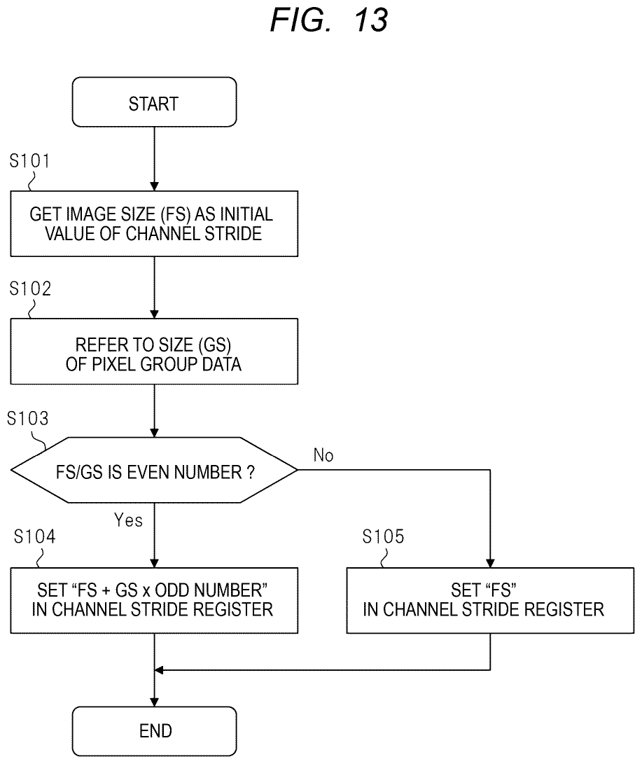

FIG. 13 is a flowchart illustrating an example of processing contents of the channel stride correction unit in FIG. 9. Here, as a premise, as described with reference to FIG. 7, it is assumed that the number of M, which is the number of memories, is 2^{m} with m being an integer of 1 or more, and the bit width of each of the M memories is 2^{k} with k being an integer of 0 or more. Further, it is assumed that a is an integer greater than or equal to 0 and less than m, the size GS of the pixel group data PGD is 2^{(k+a)} bytes, and the number of N channels is 2^{(m-a)}.

In FIG. 13, for example, the read channel stride correction unit 81 first acquires image size FS which is an initial value of a channel stride (CHstride) (step S101). That is, in the read configuration parameter 80, the setting value of the channel stride (CHstride), in other words, the initial value, is determined as the image size FS as shown in FIG. 19. In addition, the read channel stride correction unit 81 refers to the size GS of the pixel group data PGD set in advance (step S102).

Subsequently, the read channel stride correction unit 81 calculates FS/GS and determines whether or not the calculated value is an even number (step S103). When the calculation result at step S103 is an even number, the read channel stride correction unit 81 sets the value of FS+GS×odd number in the channel stride register 51 for reading (step S104). That is, the read channel stride correction unit 81 corrections the set value of the channel stride. On the other hand, when the calculation result at step S103 is an odd number, the read channel stride correction unit 81 sets the value of FS in the channel stride register 51 (step S105). That is, the read channel stride correction unit 81 does not correct the set value of the channel stride.

For example, in the case of FIG. 4, the FS/GS calculated by S103 of steps is 40 (=640/16). For this reason, for example, 640+16×1 is set in the channel stride register 51 (step S104). However, as can be seen from FIG. 4, if FS/GS is an odd number, the pixel data PD of the N channels arranged at the same pixel position are respectively stored in memory MR that differ from each other among the M memories MR without correcting the set value of the channel stride. The write channel stride correction unit 86 also performs the same processing as that of the read channel stride correction unit 81.

In addition, methods for correcting the channel stride (CHstride) are expressed by Expressions (8) and (9) by using FS bytes which is image size, K bytes which are bit width of memory MR, and M which is number of memories MR. Here, FLOOR (FS, K×M) is a function that truncates FS to a multiple of (K×M). The skip_factor is a value obtained by rounding up mod(CEIL(FS/K, 1), M) to an odd number. CEIL(FS/K, 1) is a function that rounds up the FS/K to an integral number.

$$CHstride ( pre - correction ) = FS \qquad ( 8 )$$

$$CHstride ( post - correction ) = K \times skip\_factor + FLOOR ( FS , K \times M ) \qquad ( 9 )$$

Note that, when K bytes that are bit width of the memory MR and M that is the number of memories MR are not powers of 2, the channel strides may be rounded up to the number of pixel group data PGD that are prime to the number of channels.

### Major Effect of the First Embodiment

Above, in the method of the first embodiment, the memory controller 29 is provided. The memory controller 29 controls accessing the SPM 16 such that the pixel data PD of the N channels arranged at the same pixel position are respectively stored in different memory MR in the M memories MR. Thus, the pixel data PD of the N channels can be input and output in parallel to the M memories MR. Consequently, the input/output latency between the SPM 16 and the NNE 15 can be reduced. Further, since Planar format is used as the general-purpose format, the input/output latency can be shortened even when DSP process or the like is included. As a result, the processing time of the image processing can be shortened.

Further, in the method of the first embodiment, the channel stride registers 51 and 61 and the address generators 54 and 64 are provided in the memory controller 29, and appropriate channel stride, that is, an appropriate address spacing is set in the channel stride registers 51 and 61, so that the input/output latency is shortened. Such a method using the channel stride registers 51 and 61 can reduce the number of necessary registers, which is advantageous in terms of the area of the registers, the processing load associated with the setting of the registers, and the setting time. In particular, the greater the number of channels, the more beneficial the effect.

### Second Embodiment

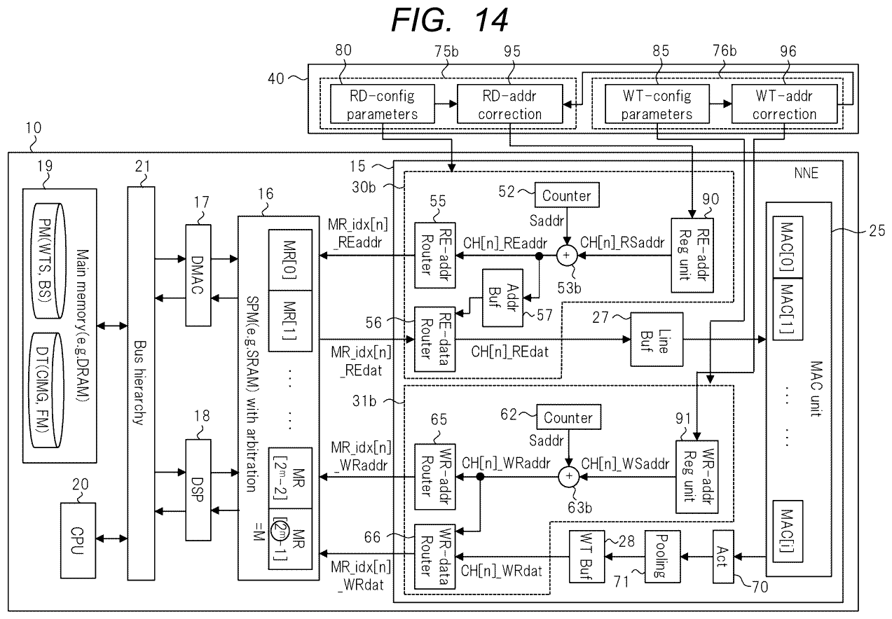

Details of the main part of semiconductor device FIG. 14 is a block diagram showing a detailed configuration of the main part in semiconductor device according to the second embodiment. The semiconductor device 10 illustrated in FIG. 14 differs from the configuration illustrated in FIG. 9 in the configuration of the read access controller 30b, the configuration of the write access controller 31b, and the configuration of the read control unit 75b and the write control unit 76b in the neural network software system 40.

The read access controller 30b comprises a read address register unit 90 instead of the read base address register 50, the channel stride register 51 and the read address generator 54 shown in FIG. 9. The read address register unit 90 comprises N address registers. In each of the N address registers, the start address CH[n]_RSaddr of the respective channels in the image data DT of the N channels is set.

The adder 53b adds the common-scan address Saddr from the address counter 52 to the N start address CH[n]_RSaddr outputted from the read address register unit 90. As a result, the adder 53b outputs the read logical address CH[n]_REaddr of the N channels in parallel as well as the output from the read address generator 54 in FIG. 9.

In accordance with such a difference, the read control unit 75b includes a read address correction unit 95 instead of the read channel stride correction unit 81 illustrated in FIG. 9. The read address correction unit 95 determines an address spacing between the channels by the same processing flow as in the case of FIG. 13, and further performs processing corresponding to the read base address register 50 and the read address generator 54 in FIG. 9. That is, the read address correction unit 95 sequentially adds the determined address spacing to a base address for a certain read, or adds an integral multiple of the address spacings, thereby calculating N start addresses CH[n]_RSaddr.

Then, the address correction unit 95 sets the calculated N start addresses CH[n]_RSaddr in the N address registers in the read address register unit 90. Consequently, as in the case of FIG. 13, the address spacing between neighboring channels in the N start address CH[n]_RSaddr is FS+GS×odd number when FS/GS is an even number. On the other hand, when FS/GS is an odd number, the address spacing between the neighboring channels is FS.

Similarly, the write access controller 31b also includes a write address register unit 91 in place of the write base address register 60, the channel stride register 61, and the write address generator 64 shown in FIG. 9. The write address register unit 91 includes N address registers. In each of the N address registers, the start address CH[n]_WSaddr of the respective channels in the image data DT of the N channels is set. The adder 63b outputs the write logical address CH[n]_WRaddr of the N channels in parallel by adding the common scan address Saddr from the address counter 62 to the N start addresses CH[n]_WSaddr output from the write address register unit 91.

The write controller 76b includes a write address correction unit 96. The write address correction unit 96 determines an address spacing between the channels. The write address correction unit 96 sequentially adds the determined address spacing to a base address for a certain write, or adds an integral multiple of the address spacing to calculate N start addresses CH[n]_WSaddr. Then, the write address correction unit 96 sets the calculated N start addresses CH[n]_WSaddr in the N address registers in the write address register unit 91.

### Main Effects of the Second Embodiment

Above, by using the method of the second embodiment, the similar effects to the various effects described in the first embodiment can be obtained. In the second embodiment, the memory controller 29 is provided with address register units 90 and 91 including N address registers, and an appropriate start address for each channel is set in the address register units 90 and 91, thereby reducing the input/output latency.

Therefore, as compared with the method of the first embodiment, a disadvantage is obtained from the viewpoint of the processing load and the setting time associated with the area of the register and the setting of the register, but an advantage is obtained from the viewpoint of increasing the degree of freedom of setting. For example, the blank area BLNK between the channels shown in FIG. 4 may be extended by any number of 128-byte units between the channels. In a typical CNN process, in particular, such a degree of freedom is often not required, but in a particular neural network process, such a degree of freedom may be required.

### Third Embodiment

### Details of the Main Part of Semiconductor Device

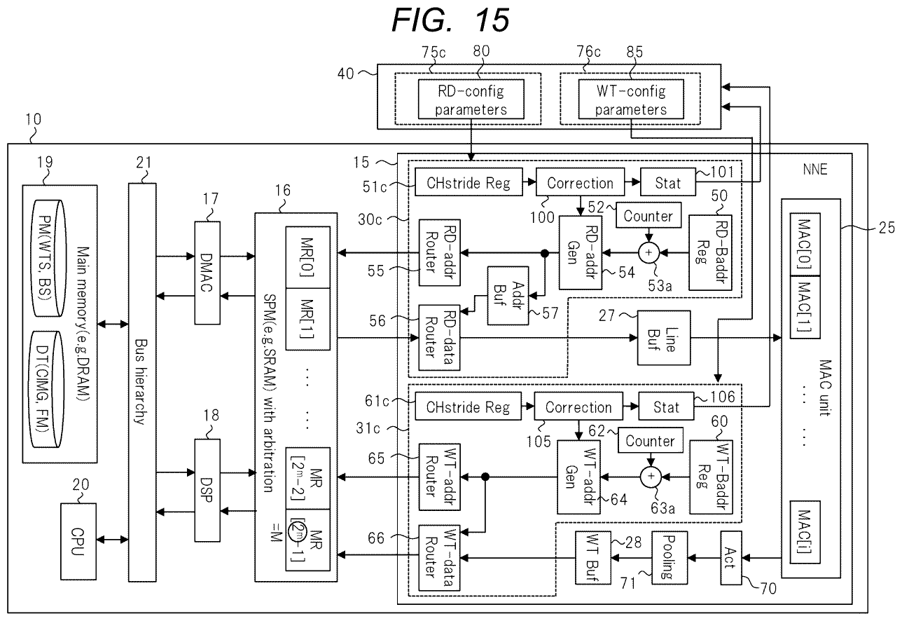

FIG. 15 is a block diagram showing a detailed configuration of the main part in semiconductor device according to the third embodiment. The semiconductor device 10 illustrated in FIG. 15 differs from the configuration illustrated in FIG. 9 in the configuration of the read access controller 30c, the configuration of the write access controller 31c, and the configuration of the read control unit 75c and the write control unit 76c in the neural network software system 40.

The write access controller 31c comprises a provisional write channel stride register 61c, a write channel stride correction circuit 105, and a write status register 106 instead of the write channel stride register 61 shown in FIG. 9. In the provisional write channel stride register 61c, a provisional value of a write channel stride, in other words, a provisional value of an address spacing is set by the write control unit 76c.

The write channel stride correction circuit 105 corrects the provisional value of the channel stride as necessary by performing the same processing as the write channel stride correction unit 86 described in FIG. 13 by a dedicated hardware circuit. Then, the write channel stride correction circuit 105 outputs the corrected value of the channel stride to the write address generator 64 and the write status register 106.

Similarly, the read access controller 30c comprises a provisional read channel stride register 51c, a read channel stride correction circuit 100, and a read status register 101 instead of the channel stride register 51 shown in FIG. 9. In the provisional read channel stride register 51c, a provisional value of a read channel stride, in other words, a provisional value of an address spacing is set by the read control unit 75c.

The read channel stride correction circuit 100 corrects the provisional value of the read channel stride as necessary by performing the same processing as that of the read channel stride correction unit 81 described in FIG. 13 by a dedicated hardware circuit. The read channel stride correction circuit 100 outputs the corrected channel stride to the read address generator 54 and the read status register 101.

The read control unit 75c reads, from the write status register 106, the channel stride after correction by the write channel stride correction circuit 105 defined by, for example, the intermediate layer in the previous stage. Then, the read control unit 75c writes the read value of the channel stride into the provisional channel stride register 51c as the value of the read channel stride in the intermediate layer or the like in the subsequent stage.

Thus, the feature map FM generated by the intermediate layer or the like in the previous stage can be used as an input in the intermediate layer or the like in the subsequent stage. At this time, since correction by the read channel stride correction circuit 100 is unnecessary, the read control unit 75c may, for example, output a control signal indicating that correction is unnecessary to the read channel stride correction circuit 100. In addition, the channel stride read from the write status register 106 is not limited to the NNE 15, and is also used in the DSP 18 and the DMAC 17.

On the other hand, the write control unit 76c reads, from the read status register 101, the channel stride corrected by the read channel stride correcting circuit 100, which is used in, for example, an intermediate layer of a certain stage. Then, the write control unit 76c writes the read value of the channel stride into the write provisional channel stride register 61c as the value of the channel stride for write in the intermediate layer or the like in the previous stage.

As a result, a memory map to be applied to the feature map FM outputted from the intermediate layer or the like in the previous stage can be determined based on the feature map FM inputted into the intermediate layer or the like. At this time, since correction by the write channel stride correction circuit 105 is unnecessary, the write control unit 76c may, for example, output a control signal indicating that correction is unnecessary to the write channel stride correction circuit 105. In addition, the channel stride read from the read status register 101 is not limited to the NNE 15, and is also used in the DSP 18 and the DMAC 17.

Note that the process in the write control unit 76c is a process that temporally goes back to the front from the rear, unlike the process in the read control unit 75c. For this reason, for example, by providing two register surfaces or the like, it is necessary to determine the value of the channel stride for reading in advance before starting the processing in the intermediate layer or the like in the previous stage. The value of the channel stride determined in advance is set as the value of the write channel stride when processing is performed in the intermediate layer or the like in the previous stage.

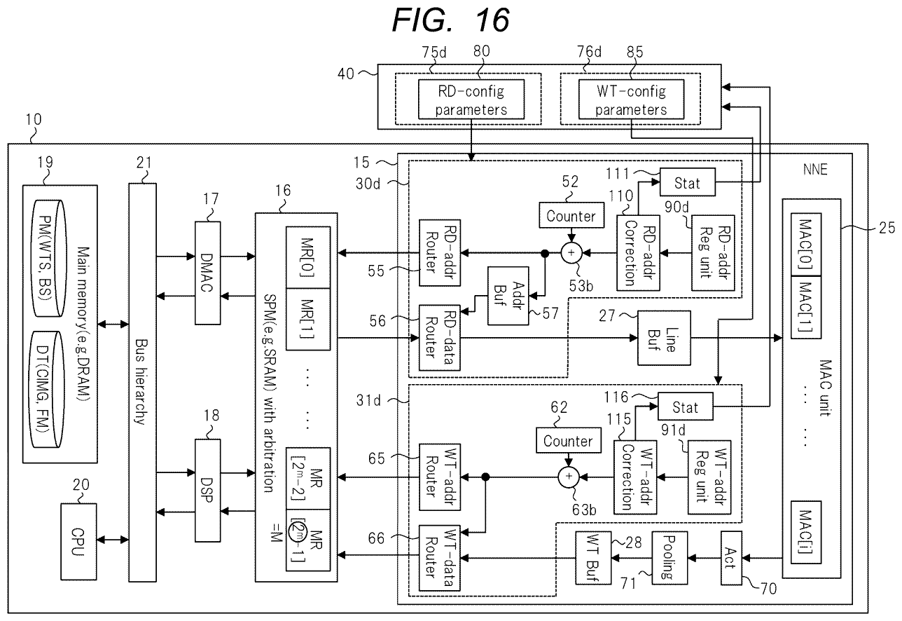

FIG. 16 is a block diagram illustrating a detailed configuration example of a main part different from that of FIG. 15. Like the case of FIG. 15, FIG. 16 shows the configuration example shown in FIG. 14 to which the method of the third embodiment is applied. The semiconductor device 10 illustrated in FIG. 16 differs from the configuration illustrated in FIG. 14 in the configuration of the read access controller 30d, the configuration of the write access controller 31d, and the configuration of the read control unit 75d and the write control unit 76d in the neural network software system 40.

In the write access controller 31d, the write address correction circuit 115 and the write status register 116 are added to the configuration shown in FIG. 14. The write address register unit 91 in FIG. 14 is replaced with a provisional address register unit 91d in FIG. 16. In the provisional address register unit 91d, a provisional value of N start addresses associated with N channels is set by the write control unit 76d.

The write address correction circuit 115 corrects the provisional values of the N start addresses as necessary by performing the same processing as the write address correction unit 96 shown in FIG. 14 by a dedicated hardware circuit. The write address correcting circuit 115 outputs the N corrected start addresses to the adder 63b and the write status register 116.

Similarly, in the read access controller 30d, a read address correcting circuit 110 and a read status register 111 are added to the configuration shown in FIG. 14. The read address register unit 90 in FIG. 14 is replaced with the provisional address register unit 90d in FIG. 16. In the provisional address register unit 90d, a provisional value of N start addresses associated with N channels is set by the read control unit 75d.

The read address correction circuit 110 corrects the provisional values of the N start addresses as necessary by performing the same processing as that of the read address correction unit 95 for reading shown in FIG. 14 by a dedicated hardware circuit. The read address correcting circuit 110 outputs the N corrected start addresses to the adder 53b and the read status register 111. The operations of the read control unit 75d and the write control unit 76d are the same as those of the read control unit 75c and the write control unit 76c described with reference to FIG. 15, except that the process target is replaced with the start address of each channel from the channel stride.

### Main Effects of the Third Embodiment

Above, by using the scheme of the third embodiment, the similar effects to the various effects described in the first embodiment or the second embodiment can be obtained. Further, the processing load of the software can be reduced by correcting the channel stride or the start address of each channel by the dedicated hardware circuit. Further, by causing the software to recognize the correction result by the hardware circuit via the status register, the software can determine the processing contents of each intermediate layer or the like, specifically, the memory map, by reflecting the correction result. As a result, it is possible to increase the efficiency of the image processing.

### Fourth Embodiment

As the architecture of the neural network for improving the recognition accuracy of images, not limited to CNN, for example, vector operation, matrix transpose (Transpose), and matrix operation (Matmul, Gemm, etc.) ViT (VisionTransformer for performing the process) and the like are known. In architectures such as ViT, vector operations, matrix transposition, and matrix operations are performed by replacing the image data with matrix structures. In this case, it is necessary to handle not only three-dimensional (X-direction, Y-direction, channel direction) data as described in the first embodiment and the like, but also D-dimensional data including four or more dimensions.

Therefore, in the fourth embodiment, the method of the first embodiment and the like is extended to D dimensions, for example, 4 dimensions, where D is an integer of 2 or more. That is, in the SPM 16, D-dimensional data is stored in Planar formats. Then, in the fourth embodiment, a method for accessing a plurality of data having D dimensions, in other words, D dimensions or D axes in parallel to the SPM 16 is shown. Note that semiconductor device according to the fourth embodiment has the same configuration as the various configurations described in the first to third embodiments. Here, it is assumed that the semiconductor device 10 has the configuration shown in FIGS. 1 and 9.

### Storage Method of the Four-Dimensional Data to the Memory

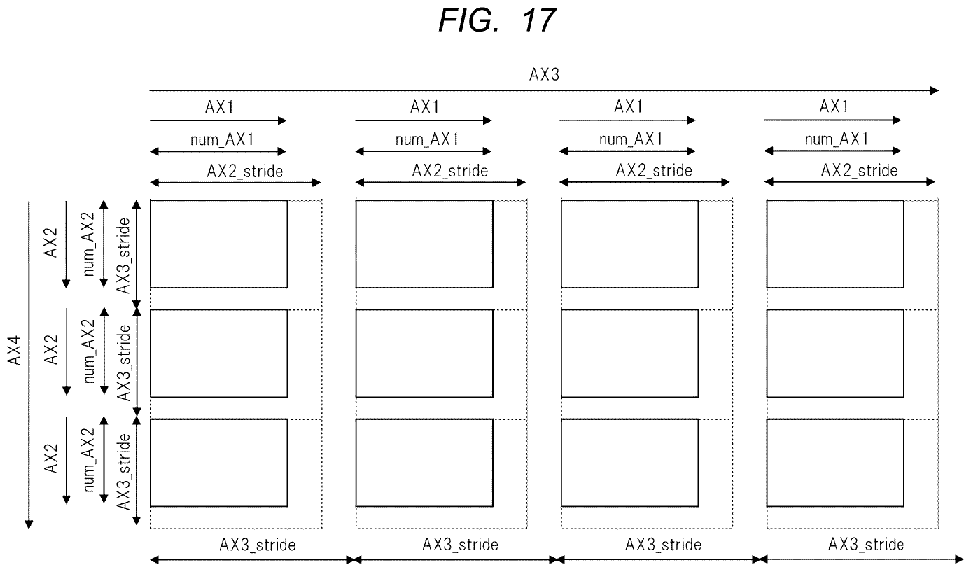

FIG. 17 is a schematic diagram showing an example of a four-dimensional data format used in semiconductor device according to the fourth embodiment. In FIG. 17, the total number of data num_ALL bytes is expressed by Expression (10). In Expression (10), num_AX1, num_AX2, num_AX3, num_AX4 is the number of elements in the first, second, third, and fourth dimensions, in other words, the first axis AX1, the second axis AX2, the third axis AX3, and the fourth axis AX4, respectively.

$$Laddr\_ 4 D = AX 1 - idx + AX 2 - idx \times AX2\_stride + AX 3 - idx \times AX3\_stride + AX 4 - idx \times AX4\_stride \qquad ( 11 )$$

FIG. 17 illustrates an example in which the number of elements in the third axis AX3 is four and the number of elements in the fourth axis is three. As shown in FIG. 17, the elements in the fourth axis AX4 from the second axis AX2 are not necessarily closely arranged in the memory MR, but are arranged with a constant stride between the elements. Here, the logical address Laddr_4D in which the 4-dimensional data DAT[AX4-idx] [AX3-idx] [AX2-idx] [AX1-idx is stored using the index (idx) values in the first axis AX1, the second axis AX2, the third axis AX3, and the fourth axis AX4 as AX1-idx, AX2-idx, AX3-idx, AX4-idx is expressed by Expression (11).

$$Num\_ALL = num\_AX1 \times num\_AX2 \times num\_AX3 \times num\_AX4 \qquad ( 10 )$$

In Expression (11), for example, for the image data, AX1-idx is an index value in the X direction (horizontal direction), AX2-idx is an index value in the Y direction (vertical direction), and AX3-idx is an index value in the channel direction. AX4-idx is an index-value that further distinguishes such three-dimensional image-data. Here, num_AX1 is Width (horizontal-image-size), num_AX2 is Height (number of lines), and num_AX3 is number of channels.

In Expression (11), AX2_stride is a stride (byte) between adjacent elements in the second axial AX2 and is a line stride in the case of image data. AX3_stride is a stride between adjacent elements in the third axial AX3 and is a channel stride in the case of image data. AX4_stride is the stride between adjacent elements in the fourth axis. The stride between adjacent elements must be greater than or equal to the number of elements of an axis that is one dimension lower in order to prevent address conflicts between adjacent elements. For this reason, the constraints shown in Expression (12A), Expression (12B), and Expression (12C) are provided.

$$AX2\_stride >= num\_AX1 \qquad ( 12 A )$$

$$AX3\_stride >= num\_AX2 \times AX2\_stride \qquad ( 12 B )$$

$$AX4\_stride >= num\_AX3 \times AX3\_stride \qquad ( 12 C )$$

Here, the memory controller 29 controls accessing to the SPM 16 so that, in two or more axes including the first axis AX1, a plurality of pieces of data having the same index value are not stored in the same memory MR in the M memories MR. At this time, the neural network software system 40 determines a read stride and a write stride, which are address spacings, and sets each of the determined strides in the read stride register and the write stride register, respectively, so that such access is performed. The read stride register and the write stride register correspond to the channel stride register 51 and the channel stride register 61 in FIG. 9, respectively.

In other words, the SPM 16 stores D-dimensional data in which the respective data in one dimension is distinguished by an index (idx) value, where D is an integer of 2 or more. The memory controller 29 controls accessing the SPM 16 such that the number of index values in the D-th dimension is N, and N pieces of data having the same index value in the first to (D-1)-th dimensions are stored in different memory MR in the M memories MR.

Consequently, for example, in the four-dimensional data DAT [AX4-idx] [AX3-idx] [AX2-idx] [AX1-idx, N pieces of data consisting of DAT [0] [0] [0] [0], DAT [1] [0] [0] [0] [0], . . . , DAT [N-1] [0] [0] [0] are stored in mutually distinct memories MR. As a result, the memory controller 29 can read the N pieces of data in parallel and write the N pieces of data in parallel to the SPM 16.

Further, the memory controller 29 may control accessing the SPM 16 such that N₁×N₂× . . . ×N_{d-1} pieces of data included in the first to (D-1)th dimensions are stored in memory MR that differ from each other in the M memories MR, with the number of index values in the 1, 2, . . . , D-1, D th dimension as N₁, N₂, . . . , N_{d-1}, N_{d} pieces, respectively. The number M of the memories MR is N₁×N₂× . . . ×N_{d-1} or more.

### Example of Memory Access

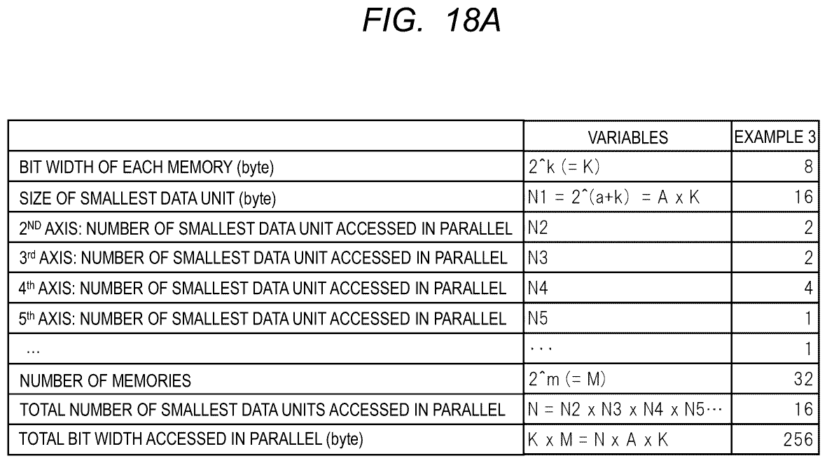

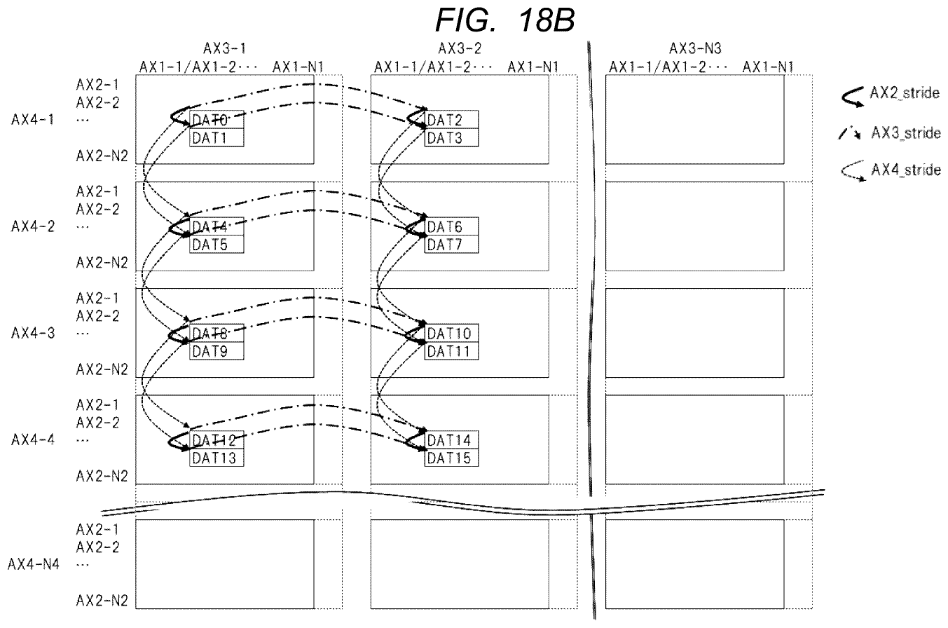

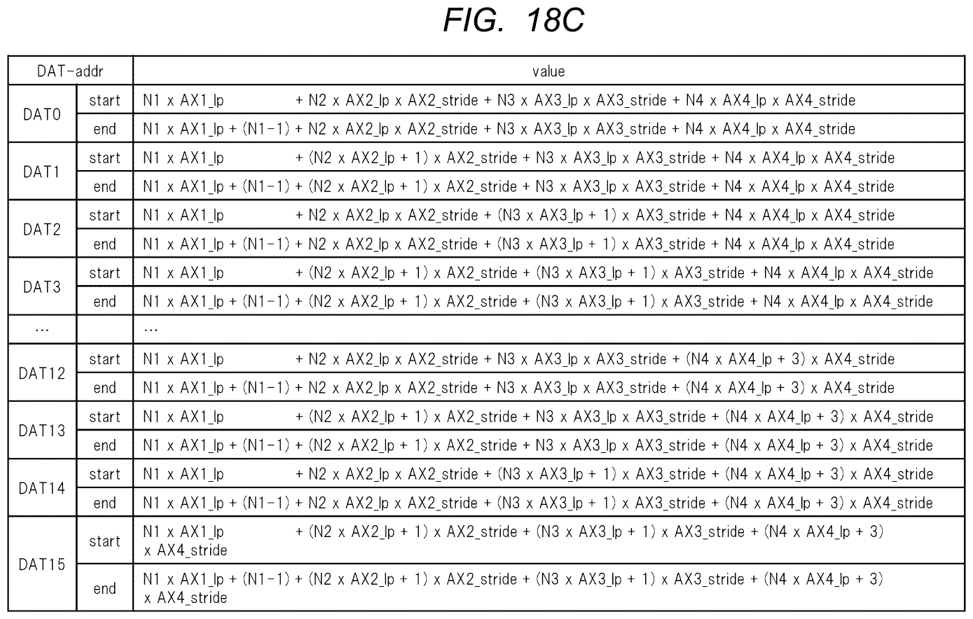

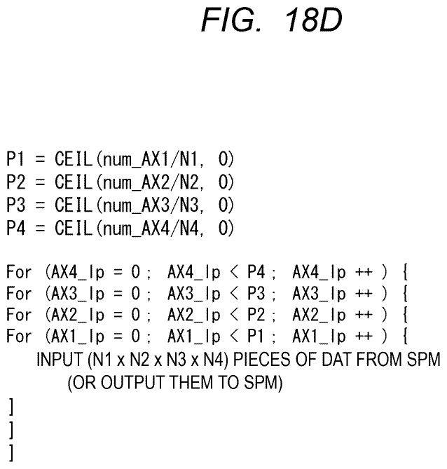

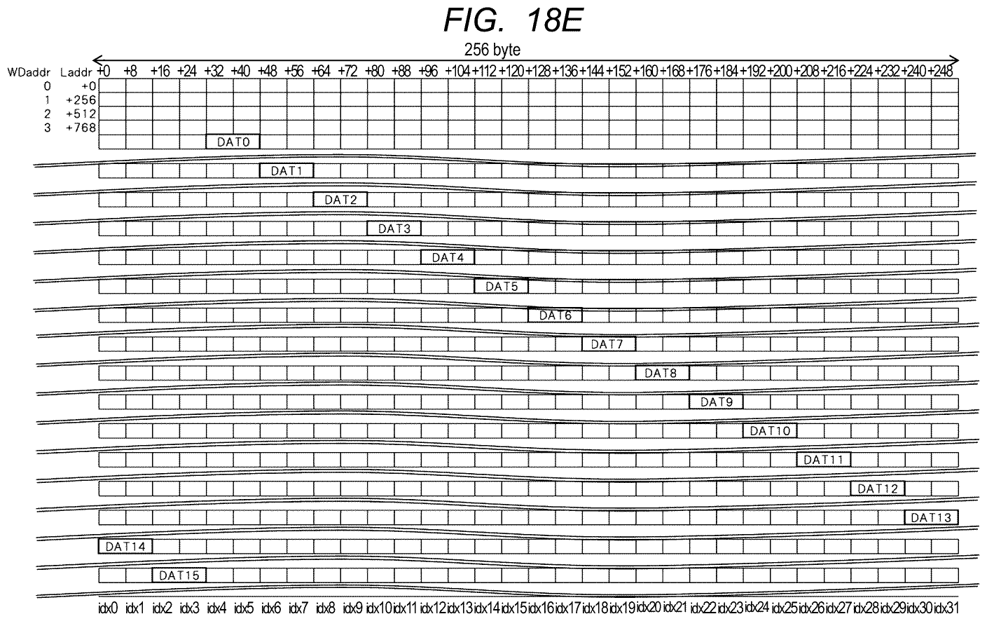

FIG. 18A is a diagram illustrating a specific example of a D-dimensional format in the semiconductor device according to a fourth embodiment. In the specific example (Example 3) shown in FIG. 18A, the values of the respective variables are the power of 2, which is generally used. The bit width K of the respective memory MR is 8 (=2^{k}) bytes, and the size N1 of the minimum data unit is 16 (=2^{(a+k)}=A×K) bytes. The size N1 of the minimum data unit is the size of the respective data in the first axial AX1, and corresponds to the size GS of the pixel group data PGD in first embodiment or the like.

The number N2, N3, N4, N5, . . . of the minimum data units accessed in parallel in the second axis AX2, the third axis AX3, the fourth axis AX4, the fifth axis AX5, . . . is the number of minimum data units that can be inputted or outputted in parallel in one clock cycle with respect to the SPM 16, for example, the number of pixel group data PGD. Here, the number N2, N3, N4, N5, . . . of the minimum data units is 2, 2, 4, 1, . . . , respectively. The number M of memories MR constituting the SPM 16 is 32 (=2^{m}). The total N of minimum data units accessed in parallel is 16 (=N2×N3×N4×N5 . . . ). The total bit width accessed in parallel is 256 (=16×16) bytes by multiplying the size N1 of the minimum data unit by the total number N.

FIG. 18B is a schematic diagram illustrating an arrangement configuration of data to be accessed in parallel in a four-dimensional format on the premise that the configuration is shown in FIG. 18A. FIG. 18B shows 16 DAT0-DAT15 that are input and output in parallel in the same clock cycle in the four-dimensional format. In the specification, a plurality of data DAT0-DAT15 are collectively referred to as a data DAT.

The size of one data DAT is 16 bytes, which is the size N1 of the minimum data unit defined in the first axial AX1. Sixteen data DAT0-DAT15 are arranged in two in the second axial AX2 using the stride AX2_stride for the second axial. Similarly, 16 DAT0-DAT15 are arranged in two in the direction of the third axis AX3 using a stride AX3_stride for the third axis, and are arranged in four in the direction of the fourth axis AX4 using a stride AX4_stride for the fourth axis.

FIG. 18C is a diagram showing the start address and the end address of the respective pieces of data shown in FIG. 18B. In the respective DAT, the end address is the sum of the start address and N1-1. Further, for example, the start address of the data DAT1 is obtained by adding the stride AX2_stride of the second axis to the start address of the data DAT0. The start address of the data DAT2 is a value obtained by adding the stride AX3_stride of the third axis to the start address of the data DAT0. The start address of the data DAT3 is obtained by adding the stride AX2_stride of the second axis to the start address of the data DAT2.

FIG. 18D is a diagram illustrating an exemplary neural network software executed by CPU on the premise that the configuration is illustrated in FIG. 18A. The CPU 20 executes multiple-loop programming, for example, as shown in FIG. 18D, which increases in dimension toward the outer side. At this time, the CPU 20 causes the neural network engine (NNE) 15 to perform the arithmetic process associated with the multi-loop. Accordingly, the NNE 15 needs to input or output N1×N2×N3×N4 pieces of data, here, 16 pieces of data DAT0 to DAT15, to the SPM 16.

Therefore, the CPU 20 sets, for example, a read stride or a write stride as shown in Expression (13A) to Expression (13C) for the read stride register corresponding to the channel stride register 51 shown in FIG. 9 or the write stride register corresponding to the channel stride register 61. That is, the CPU 20 corrects the stride AX2 stride for the second axis to satisfy the constraint of Expression (12A) and add the size N1 (=16 byte to the multiple of 256 bytes (256n), which is K×M, as shown in Expression (13A). As described above, the size N1 is the size of the minimum data units in the first axial AX1, in other words, the size of the packet group data PGD.

Further, the CPU 20 corrects the stride AX3_stride for the third axis so as to be a value adding a multiple of 256 bytes (256n) and N1×N2 that is the multiplication result of the size N1 and the number N2 while satisfying the constraint of the expression (12B). As described above, the number N2 is the number of the minimum data unit to be accessed in parallel in the second axial AX2. Further, the CPU 20 corrects the stride AX4_stride for the fourth axis so as to be a value adding a multiple of 256 bytes (256n) and N1×N2×N3 that is the multiplication result of the size N1, the number N2, and the number N3 while satisfying the constraint of the Expression (12C). As described above, the number N3 is the number of the minimum data unit to be accessed in parallel in the third axial AX3.

$$AX2\_stride = 256 n + N 1 \qquad ( 13 A )$$

$$AX3\_stride = 256 n + N 1 \times N 2 \qquad ( 13 B )$$

$$AX4\_stride = 256 n + N 1 \times N 2 \times N 3 \qquad ( 13 C )$$

As a result, a memory map as shown in the drawing 18E is formed. FIG. 18E is a diagram illustrating an exemplary memory map of the respective data that is stored in the scratchpad memory (SPM) after the stride correction is performed on the premise that the specifics shown in FIG. 18C. As shown in FIG. 18E, by performing stride corrections, sixteen data DAT0-DAT15 are assigned to different idx in the SPM 16 and stored in different memory MR, here 32 memories MR. As a result, the NNE 15 can input and output 16 DAT0-DAT15 to and from the SPM 16 in parallel. As a result, the input/output latency can be shortened.

### Main Effects of the Fourth Embodiment

As described above, by using the method of the fourth embodiment, the similar effects to the various effects described in the first to third embodiments can be obtained. Further, the same effect can be obtained with respect to the data in the D dimension which is two or more dimensions.

Although the invention made by the present inventor has been specifically described based on the embodiment, the present invention is not limited to the embodiment described above, and it is needless to say that various modifications can be made without departing from the gist thereof.

What is claimed is:

1. A semiconductor device comprising;
a scratchpad memory storing image data of N channels and including M memories which are individually accessible, where M is an integer of 2 or more and N is an integer of 2 or more;
a memory controller configured to control access to the scratchpad memory such that pixel data of the N channels which are arranged at a same pixel position in image data of the N channels are respectively stored in different memories of the M memories;
an MAC (multiply-accumulation) unit including a plurality of calculators to calculates pixel data of the N channels read from the scratchpad memory by using the memory controller and a weight parameter.

2. The semiconductor device according to claim 1,
wherein the memory controller includes:
a read access controller configured to generates read logical al addresses of the N channels for reading the pixel data of the N channels, respectively, when the pixel data of the N channels are read from the scratchpad memory, and
a write access controller configured to generate write logic addresses of the N channels for storing the pixel data of the N channels, respectively, when the pixel data of the N channels are written to the scratchpad memory.

3. The semiconductor device according to claim 2,
wherein the read access controller includes a read address router which is configured to translate the read logical addresses of the N channels into read physical addresses of the M memories to output the read physical addresses of the N channels to the M memories each associated with one of the N channels, and
wherein the write access controller includes a write address router which is configured to translate the write logic addresses of N channels into write physical addresses for the M memories each associated with one of the N channels to output the write physical addresses to the M memories.

4. The semiconductor device according to claim 3,
wherein the write access controller includes a write data router which is configured to output the pixel data of the N channels obtained based on calculation results of the MAC unit to the M memories each associated with one of channel of the N channels.

5. The semiconductor device according to claim 3,
wherein the read address router identifies a correspondence between the N channels and the M memories by a value of a particular bit area included in the read logical al addresses of the N channels, and
wherein the write address router identifies the corresponding the N channels and the M memories by a value of a particular bit area included in the write logical addresses of the N channels.

6. The semiconductor device according to claim 5,
wherein the read access controller further includes:
a read data router configured to rearrange the pixel data of the N channels read from the M memories based on the read physical addresses from the read address router in a channel order, and
an outstanding address buffer configured to buffer the particular bit area of the read logical al address of the N channels for a period based on read latency of the M memories,
wherein the read data router receives the particular bit area of the read logical address of the N channels from the outstanding address buffer, and
wherein he MAC unit receives the pixel data of the N channels rearranged by the read data router.

7. The semiconductor device according to claim 2,
wherein an access controller is the read access controller or the write access controller, and
wherein the access controller includes:
a channel stride register in which an address spacing between start addresses of the image data of neighboring channels of the N channels stored in the scratchpad memory is set, and
an address generator which add an integral multiple of the address spacing to a reference logical address to generate logical addresses for the N channels in the scratchpad memory.

8. The semiconductor device according to claim 7,
wherein the access controller accesses the scratchpad memory with a pixel data group including a plurality of the pixel data as a data unit,
wherein the M memories each have a bit width of 2^{k} bytes, where a value of M is 2^{m}, m is an integer of 1 or more and k is an integer of 0 or more,
wherein the channel stride register is set to FS+GS×odd number when FS/GS is an even number, and is set to FS when FS/GS is an odd number, where FS is a byte size of each of the image data of the N channels, GS is a byte size of the pixel data group or 2^{(k+a)} bytes, a is an integer of 0 or more and less than m, a value of N is 2^{(m-a)} number.

9. The semiconductor device according to claim 2,
wherein an access controller is the read access controller or the write access controller, and
wherein the access controller includes:
N address registers storing N start addresses, respectively, each of the N start address being a start address of an image data of an associated one channel of the N channels, and
an adder adding a common scan address to each of the N start addresses.

10. The semiconductor device according to claim 9,
wherein the access controller accesses the scratchpad memory with a pixel data group including a plurality of the pixel data as a data unit,
wherein the M memories each have a bit width of 2^{k} bytes, where a value of M is 2^{m}, m is an integer of 1 or more and k is an integer of 0 or more,
wherein the address spacing between start addresses of the image data of neighboring channels of the N channels is set to FS+GS×odd number when FS/GS is an even number, and is set to FS when FS/GS is an odd number, where FS is a byte size of each of the image data of the N channels, GS is a byte size of the pixel data group or 2^{(k+a)} bytes, a is an integer of 0 or more and less than m, a value of N is 2^{(m-a)} number.

11. The semiconductor device according to 1, further comprising:
a DMA (Direct Memory Access) controller configured to control data transfer between the scratchpad memory and a main memory.

12. The semiconductor device according to claim 1, further comprising:
a DSP (Digital Signal Processor) performing signal operations on the image data of the N channels stored in the scratchpad memory.

13. A semiconductor device comprising:
a scratchpad memory storing image data of N channels and including M memories which are individually accessible, where M is an integer of 2 or more and N is an integer of 2 or more;
a memory controller configured to control access to the scratchpad memory based on a setting value of a register;
a CPU (Central Processing Unit) configured to determine the setting value of the register for the memory controller; and
a MAC (Multiply Accumulation) unit including a plurality of calculators,
wherein the CPU determines the setting value of the register such that pixel data of N channels which are arranged at a same pixel position in image data of the N channels are respectively stored in different memories of the M memories, and wherein each of the calculators performs a multiply-accumulation operation on the pixel data of the N channels read from the scratchpad memory by using the memory controller and a weight parameter.

14. The semiconductor device according to claim 13,
wherein the memory controller includes:
a channel stride register in which an address spacing between start addresses of the image data of neighboring channels of the N channels stored in the scratchpad memory is set, and
an address generator which adds an integral multiple of the address spacing to a reference logical address to generate logical addresses for the N channels in the scratchpad memory, and
wherein the CPU sets the address spacing in the channel stride register.

15. The semiconductor device according to claim 14,
wherein the memory controller accesses the scratchpad memory with a pixel data group including a plurality of the pixel data as a data unit,
wherein the M memories each have a bit width of 2^{k} bytes, where a value of M is 2^{m}, m is an integer of 1 or more and k is an integer of 0 or more,
wherein the CPU set FS+GS×odd number in the channel stride register when FS/GS is an even number and set FS when FS/GS is an odd number, where FS is a byte size of each of the image data of the N channels, GS is a byte size of the pixel data group or 2^{(k+a)} bytes, a is an integer of 0 or more and less than m, a value of N is 2^{(m-a)} number.

16. The semiconductor device according to claim 13,
wherein the memory controller includes:
N address registers storing N start addresses, respectively, each of the N start addresses being a start address of an image data of an associated one channel of the N channels, and
an adder adding a common scan address to each of the N start addresses,
wherein the CPU sets the N start addresses in the N address registers.

17. The semiconductor device according to claim 16,
wherein the memory controller accesses the scratchpad memory with a pixel data group including a plurality of the pixel data as a data unit,
wherein the M memories each have a bit width of 2^{k} bytes, where a value of M is 2^{m}, m is an integer of 1 or more and k is an integer of 0 or more,
wherein the address spacing between start addresses of the image data of neighboring channels of the N channels is set to FS+GS×odd number when FS/GS is an even number, and is set to FS when FS/GS is an odd number, where FS is a byte size of each of the image data of the N channels, GS is a byte size of the pixel data group or 2^{(k+a)} bytes, a is an integer of 0 or more and less than m, a value of N is 2^{(m-a)} number.

18. A semiconductor device comprising:
a scratchpad memory storing D-dimensional data and including M memories which are individually accessible, the D-dimensional data being configured such that each data in one dimension is distinguished by an index value, where D is an integer of 2 or more and M is an integer of 2 or more, and
a memory controller configured to control access to the scratchpad memory such that N pieces of data having a same index value in the first to (D-1) th dimensions are respectively stored in different memories in the M memories, with the number of the index value in the D dimension being N.
